(19) United States
(12) Patent Application Publication
(10) Pub. No.: US 2023/0055896 A1
(43) Pub. Date: Feb. 23, 2023

(54) SOLID-STATE ELECTROLYTE, CATHODE ELECTRODE, AND METHODS OF MAKING SAME FOR SULFIDE-BASED ALL-SOLID-STATE-BATTERIES

(71) Applicant: Northeastern University, Boston, MA (US)

(72) Inventors: Hongli Zhu, Arlington, MA (US); Daxian Cao, Boston, MA (US)

(21) Appl. No.: 17/820,662

(22) Filed: Aug. 18, 2022

Related U.S. Application Data
(60) Provisional application No. 63/235,571, filed on Aug. 20, 2021.
(60) Provisional application No. 63/253,440, filed on Oct. 7, 2021.

(51) Int. Cl. H01M 10/0562; H01M 10/0525; H01M 10/054; C01G 15/00

(52) U.S. Cl. CPC H01M 10/0562; H01M 10/0525; H01M 10/054; C01G 15/006; C01P 2006/40; H01M 2300/008

(57) ABSTRACT

Current sulfide solid-state electrolyte (SE) membranes utilized in all-solid-state lithium batteries (ASLBs) have a high thickness (0.5˜1.0 mm) and low ion conductance (<25 mS), which limit the cell-level energy and power densities. Based on ethyl cellulose's unique amphipathic molecular structure, superior thermal stability, and excellent binding capability, this work fabricated a freestanding SE membrane with an ultralow thickness of 47 μm. With ethyl cellulose as an effective disperser and binder, the Li₆PS₅Cl is uniformly dispersed in toluene and possesses superior film formability. In addition, ultralow areal resistance of 5.10 Ωcm⁻² and remarkable ion conductance of 190.11 mS (one order higher than the conventional sulfide SE layer) have been achieved. The ASLB assembled with this SE membrane delivers cell-level high gravimetric and volumetric energy densities of 175 Wh kg⁻¹ and 675 Wh L⁻¹, individually.

### RELATED APPLICATIONS

This application claims the benefit of U.S. Provisional Application No. 63/235,571, filed on Aug. 20, 2021. This application claims the benefit of U.S. Provisional Application No. 63/253,440, filed on Oct. 7, 2021. The entire teachings of the above applications are incorporated herein by reference.

### GOVERNMENT SUPPORT

This invention was made with government support under Grant Number 1924534 from the National Science Foundation. The government has certain rights in the invention.

### BACKGROUND

All-solid-state lithium batteries (ASLBs) coupling solid-state electrolytes (SEs) with high-energy electrodes are considered for applications such as electric vehicles (EVs) and portable electronics. However, most reported ASLBs delivered far lower energy densities (<50 Wh kg⁻¹, <100 Wh L⁻¹) at the cell level, which is mainly attributed to the utilization of thick electrolyte membranes. These high thicknesses not only dramatically reduce the cell-level energy density but also increase the internal resistance. To achieve cell-level high energy density and efficiency for practical application, the SE membrane must simultaneously possess a low thickness and high ionic conductivity. However, when reducing the thickness, the membrane can become brittle. Existing solution casting and dry film fabrication methods for fabricating thin SE membranes generally result in membranes with reduced ionic conductivity.

### SUMMARY

Described herein are methods of making a solid-state electrolyte. The methods involve dissolving ethyl cellulose in a nonpolar solvent; dispersing a sulfide solid electrolyte in the nonpolar solvent; casting the dispersion of the sulfide solid electrolyte in the nonpolar solvent under vacuum filtration to form a thin membrane; and heating the thin membrane to remove the nonpolar solvent, thereby forming a solid-state electrolyte.

A variety of non-polar solvents are suitable, including toluene, hexane, p-xylene, benzene, and diethyl ether. The sulfide solid electrolyte can be Li₆PS₅Cl.

The solid-state electrolyte can have a thickness from about 20 μm to about 50 μm, such as a thickness of about 50 μm, or a thickness of less than 50 μm.

The solid-state electrolyte can have a resistance of less than 20Ω at 30° C., a resistance from 5Ω to 20Ω at 30° C., or a resistance of about 5.26Ω at 30° C.

The solid-state electrolyte can have a conductivity of at least 0.75 mS cm⁻¹ at 30° C., or a conductivity from 0.75 mS cm⁻¹ to 5 mS cm⁻¹ at 30° C., or a conductivity of about 1.08 mS cm⁻¹ at 30° C.

The solid-state electrolyte can have an ion conductance of at least 150 mS at 30° C., or an ion conductance from about 150 mS to about 300 mS at 30° C., or an ion conductance of about 190 mS at 30° C.

The solid-state electrolyte can have from about 1 wt. % ethyl cellulose to about 5 wt. % ethyl cellulose.

Ideally, the membrane does not have any pores. The solid-state electrolyte can have less than about 1 vol % pores. The solid-state electrolyte can have from about 0.05 vol. % pores to about 3 vol. % pores. The solid-state electrolyte can have about 0.094 vol. % pores.

Chlorine, sulfur, and phosphorus can be homogeneously distributed throughout the solid-state electrolyte. In addition, the ethyl cellulose can form point contacts and therefore does not block ion conductance of the solid state electrolyte.

In some embodiments, the solid-state electrolyte does not fracture when subjected to 90 MPa of axial compression.

Described herein is a method of making a cathode. The method involves dissolving LiCl in water; dissolving InCl₃ in the water; dispersing LiCoO₂ in the water; heating the water with dissolved LiCl, dissolved InCl₃, and dispersed LiCoO₂ to remove the water, thereby forming a mixture of LiCoO₂ and Li₃InCl₆; and annealing the mixture of LiCoO₂ and Li₃InCl₆.

The LiCl and the InCl₃ can be in a weight ratio of about 1:3. The LiCoO₂ and the Li₃InCl₆ can be in a weight ratio from about 75:25 to about 90:10. The LiCoO₂ and the Li₃InCl₆ can be in a weight ratio of about 80:20.

Described herein is a battery. The battery includes a cathode current collector; a cathode that includes LiCoO₂ and Li₃InCl₆; a solid-state electrolyte that includes a sulfide solid electrolyte and ethyl cellulose; an anode; and an anode current collector.

The sulfide solid electrolyte can be Li₆PS₅Cl.

The battery can have a discharge capacity of at least 150 mAh g⁻¹, such as a discharge capacity of about 172 mAh g⁻¹.

The battery can have an initial coulombic efficiency of at least 95%, such as an initial coulombic efficiency of about 98.3%.

The battery can have an E₁ energy density of about 175 Wh kg⁻¹, or an E₁ energy density of about 670 Wh L⁻¹.

The anode can include indium and lithium. The cathode current collector can be formed of stainless steel. The anode current collector can be formed of copper.

Described herein is a method of making a battery. The method includes pressing together: i) a cathode that includes LiCoO₂ and Li₃InCl₆; ii) a solid-state electrolyte that includes a sulfide solid electrolyte and ethyl cellulose; and iii) an anode that includes indium and lithium. The method also includes attaching a cathode current collector to the cathode and attaching an anode current collector to the anode.

Embodiments described herein have many features, advantages, and uses. An extra coating or interface engineering on the cathode is not needed. High-cost facilities and high-temperature treatment are also not employed. The water-mediated approach shows suitability for large-scale applications. The methods are scalable and yield high performance products, and the costs are low. The methods of making a cathode described herein are more scalable than sol-gel methods and atomic layer deposition (ALD) methods.

The ionic conductivity of the electrolyte can be 0.5×10⁻³ S cm⁻¹, which is three to four orders higher than that of conventional coating materials. The LiCoO₂ is highly stable with Li₃InCl₆, which avoids the side effect occurring in the use of sulfide electrolyte. An intimate contact between LiCoO₂ and Li₃InCl₆ is achieved, which excludes the interface resistance caused by insufficient interface contact. An ASLB employing cathodes described herein can exhibit a high specific energy of 533 Wh kg⁻¹ and 426 Wh kg⁻¹ based on the cathode solely and total cathode layer, respectively. The halide is easy to recycle after harvesting from the obtained cathode.

Embodiments described herein show a potential to address the cathode interface incompatibility issue in all kinds of ASLBs. Embodiments described herein can be applied in large scale industrial manufacturing. Methods described herein can be used to prepare other cathodes, like nickel-rich LiNi_{0.8}Mn_{0.2}Co_{0.2}O₂, Li₂FeMn₃O₈, and LiNi_{0.8}Co_{0.15}Al_{0.05}O₂ et al.

Embodiments described herein can be used in a wide variety of applications, including electrical vehicles and portable electronics. Highly stable cathodes can be used in all-solid-state batteries. Embodiments can be applied in the fabrication of a thin solid electrolyte layer. 8. Can be applied in the fabrication of a thin solid electrolyte layer.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIGS. 1A-F are an overview of this work. FIG. 1A is an illustration of compatibility among sulfide SE, binder, and solvent. FIGS. 1B-D are schematic to display the effect of binder on thermal stability (FIG. 1B), ionic conductivity (FIG. 1C), and mechanical strength (FIG. 1D) of the SE membrane. FIG. 1E is an illustration of compatibility among Li₆PS₅Cl, ethyl cellulose, and toluene in thin membrane fabrication. FIG. 1F is a graph of estimated gravimetric and volumetric energy density of ASLBs as the factor of the thickness of SE layers in ASLB coupling LiCoO₂ and Li metal.

FIGS. 2A-K show fabrication of the thin SE membrane. FIG. 2A is a photo of the Li₆PS₅Cl dispersions in toluene with/without ethyl cellulose. FIG. 2B is an FTIR spectra of ethyl cellulose and cellulose. Insets are chemical structures of ethyl cellulose and regular cellulose individually. FIG. 2C is a graph showing viscosity as a function of the shear rate for various dispersions or solutions: Li₆PS₅Cl-ethyl cellulose in toluene, Li₆PS₅Cl in toluene, Li₆PS₅Cl-cellulose in toluene, ethyl cellulose in toluene, and cellulose in toluene. FIG. 2D is a schematic of the binder-assisted vacuum filtration method in fabricating the thin SE membrane. FIG. 2E is a photo of the thin SE membrane composed of Li₆PS₅Cl and ethyl cellulose. FIG. 2F is a photo of the thin SE membrane with only Li₆PS₅Cl. FIG. 2G is a photo of bent thin SE membrane to show the flexibility. FIG. 2H is a photo of thick SE pellet. FIG. 2I is photos of the thin SE membrane (top) and thick SE pellet (bottom) in thickness measurement. FIGS. 2J-K are stress-strain profiles of thin SE membrane (FIG. 2J) and thick SE pellet (FIG. 2K) in an axial compression process.

FIGS. 3A-K show the performance of the thin SE membrane. FIG. 3A is a cross-sectional SEM image of the thin SE membrane. FIG. 3B is an EDS mapping of the thin SE membrane. FIGS. 3C-D are cross-sectional SEM images of thin SE membrane with magnitudes of ×1 k (FIG. 3C) and ×10 k (FIG. 3D). FIG. 3E is an SEM image showing the surface morphology of the thin SE membrane from the top view. FIG. 3F is XRD patterns of the thin and thick SEs. FIG. 3G is Raman spectra of the thin and thick SEs. FIG. 3H is Nyquist plots in AC impedance measurement of the thin and thick SEs. FIG. 3I is a graph of temperature-dependent ion conductance of the thin and thick SEs. FIG. 3J is a graph of temperature-dependent areal resistances of the thin and thick SEs. FIG. 3K is a graph comparing the ion conductance at 30° C. of this SE membrane with other reported sulfide thin SE membranes.

FIGS. 4A-L show the distribution of Li₆PS₅Cl and ethyl cellulose in thin SE membrane revealed by X-ray computed tomography. FIGS. 4A-D are reconstructed 2D images of the thin SE membrane in the surface (FIG. 4A) and the distribution of Li₆PS₅Cl labeled with yellow color (FIG. 4B), ethyl cellulose marked with red color (FIG. 4C), and pores tagged with blue color (FIG. 4D). FIGS. 4E-H are magnified surface images of the thin membrane (FIG. 4E) and the distribution of Li₆PS₅Cl labeled with yellow color (FIG. 4F), ethyl cellulose marked with red color (FIG. 4G), and pores labeled with blue color (FIG. 4H). FIGS. 4I-L are 3D segmented images of a 500×500×50 μm subvolume of the thin SE membrane (FIG. 4I), and the renderings to show the distribution of Li₆PS₅Cl labeled with yellow color (FIG. 4J), ethyl cellulose tagged with red color (FIG. 4K), and pores marked with blue color (FIG. 4L).

FIGS. 5A-I show stabilization of the cathode layer. FIGS. 5A-B are schematics to illustrate the sluggish ion transfer at the LiCoO₂/Li₆PS₅Cl interface caused by the side reaction (the brown region represent newborn interphase with high resistance) (FIG. 5A) and the excellent compatibility at the LiCoO₂/Li₃InCl₆ interface induced fast ion transfer (FIG. 5B). FIG. 5C is an XRD spectra of pure Li₃InCl₆, LiCoO₂, and Li₃InCl₆—LiCoO₂ composites. FIG. 5D is a cross-section of an SEM image of the cathode-SE layers. FIGS. 5E-I are EDS mapping of overall elements (FIG. 5E), Co (FIG. 5F), In (FIG. 5G), Cl (FIG. 5H), and S (FIG. 5I) in the cross section of the cathode-SE layers.

FIGS. 6A-G show the performance of ASLBs. FIGS. 6A-C are schematics of the cell architecture of Li₆PS₅Cl—LiCoO₂/thick SE (FIG. 6A), Li₃InCl₆—LiCoO₂/thick SE (FIG. 6B), and Li₃InCl₆—LiCoO₂/thin SE (FIG. 6C). FIG. 6D is charge/discharge profiles of three cells in the first cycle. FIG. 6E is the amplified charge profile of three cells in the first cycle. FIG. 6F is the rate performances of three cells. FIG. 6G shows the long-term cycling stabilities of cell 2 and cell 3 at C/5 in room temperature.

FIGS. 7A-B are an energy densities evaluation. FIGS. 7A-B show gravimetric energy density (FIG. 7A) and volumetric energy density (FIG. 7B) of Cell 3 at E₁ (cathode, SE, and anode), E₂ (cathode and SE), and E₃ (cathode, SE, and Li metal) levels in comparison with other reported ASLBs using LiCoO₂ cathode, sulfide SE, and In (or In—Li) anode.

FIG. 8A-C show membrane fabrication using flax as building blocks. FIGS. 8A-C are photos of raw flax (FIG. 8A), the dispersion of flax in toluene after mechanical stirring (FIG. 8B), and membranes composing of flax and Li₆PS₅Cl (FIG. 8C). After the mechanical stirring, the length of flax fiber reduced a lot. Thus, flax can disperse in toluene. However, the obtained membrane broke a little while peeling off the filler paper, suggesting poor mechanical strength.

FIGS. 9A-D show membrane fabrication using 2,2,6,6-tetramethylpiperidine-1-oxyl (TEMPO) oxidized cellulose nanofiber grafted with Polyethylene glycol (CNF-PEG) as building blocks. FIGS. 9A-D are photos of CNF-PEG (FIG. 9A), the dispersion of CNF-PEG in toluene after mechanical stirring (FIG. 9B), the dispersion of CNF-PEG in toluene after standing for 1 min, and membranes composing of CNF-PEG and Li₆PS₅Cl (FIG. 9D). To obtain a uniform dispersion of CNF in toluene, we grafted PEG on the CNF through an as-reported ion-exchange treatment. The CNF-PEG uniformly dispersed in toluene after mechanically stirring for 2 h, but precipitated after standing for 1 min. After filtration, the membrane broke into several pieces, suggesting poor mechanical strength.

FIG. 10A-B are photos of the dispersion of cellulose (FIG. 10A), and ethyl cellulose (FIG. 10B) in toluene to compare the solubility.

FIG. 11 is a thermogravimetric analysis of ethyl cellulose.

FIG. 12 is a photo of SE membrane after punch to show the robustness.

FIGS. 13A-B are Nyquist plots of thick SE pellet in overall (FIG. 13A) and high frequencies range (FIG. 13B) in ionic conductivity measurement at various temperature.

FIGS. 14A-B are Nyquist plots of thin SE membrane in overall (FIG. 14A) and high frequencies range (FIG. 14B) in ionic conductivity measurement at various temperature.

FIG. 15 is a photo of the dispersion of Li₆PS₅Cl and regular cellulose in toluene after standing for one min.

FIG. 16A is a photo of the as prepared SE membrane composed with Li₆PS₅Cl and regular cellulose. FIG. 16B is a photo of the as-punched membrane after cold press.

FIGS. 17A-B are Nyquist plots of SE membrane composed with 10 wt. % of regular cellulose in overall (FIG. 17A) and high frequencies range (FIG. 17B) in ionic conductivity measurement at 30° C.

FIGS. 18A-B are Nyquist plot of Li₃InCl₆ in ionic conductivity measurement.

FIG. 19 is a table showing a performance comparison with other reported thin SE membrane.

FIG. 20 is a table showing ion conduction comparison between thin SE and thick SE at various temperature.

FIG. 21 is a table showing an energy density comparison.

FIG. 22 is a table showing parameters for energy density evaluation.

FIG. 23 is a schematic of an all-solid-state lithium battery (ASLB).

FIG. 24 is a tensile stress-strain curve of the thin SE membrane. The inset photos show the sample before and after the tensile test.

FIG. 25 is a Nyquist plot of the bare cell to test external resistance.

FIG. 26 is a graph showing critical current density investigation of SE with Li metal in a symmetric cell.

### DETAILED DESCRIPTION

A description of example embodiments follows.

### INTRODUCTION

Safety issues and insufficient energy density (<250 Wh kg⁻¹) are two main concerns when applying commercial lithium-ion batteries (LiBs) to applications such as electric vehicles (EVs) and portable electronics.^{[1, 2]} All-solid-state lithium batteries (ASLBs) coupling solid-state electrolytes (SEs) with high-energy electrodes are considered an effective solution to overcome these two challenges.^{[3]} Most SEs, especially the ceramic types, are incombustible, naturally non-volatile, and have excellent thermal stability.^{[4]} The employment of SEs would intrinsically address the thermal runaway caused by flammable organic liquid electrolytes in conventional LiBs. Additionally, SEs possessing a high elastic modulus are regarded to suppress the metallic anode Li metal dendrite growth.^{[5]} The employment of Li metal can significantly boost the energy densities of the ASLBs. Furthermore, due to their solid state, SEs could enable the ASLBs a bipolar cell architecture, which would allow the cells to be stacked, further enhancing the energy densities.^{[6, 7]} Thus, ASLBs are highly promising to achieve high safety and the desired energy densities (>500 Wh kg⁻¹, >700 Wh L⁻¹) to meet the demand of EVs.^{[2]}

However, most reported ASLBs delivered far lower energy densities (<50 Wh kg⁻¹, <100 Wh L⁻¹) at the cell level.^{[8]} This dramatic drop is mainly attributed to the utilization of thick electrolyte membranes. Note that the evaluation of cell-level energy density includes the masses and volumes of all parts of the batteries. In a sheet-type ASLB, an ideal SE membrane should concurrently have low areal resistance, high ion conductance, low thickness, high mechanical and chemical stability, and light weight. The state-of-the-art membrane in LiBs with liquid electrolytes has a thickness of ˜20 In contrast, most reported solid inorganic electrolyte membranes show much higher thickness (0.5˜1.0 mm).^{[9]} These high thicknesses not only dramatically reduce the cell-level energy density but also increase the internal resistance. Although some inorganic electrolytes, especially the sulfide SE, can exhibit room-temperature ionic conductivity σ of >1.0 mS cm⁻¹, the areal resistance R of the SE membrane is as high as 100 Ωcm², calculated based on R=r*A=l/σ, where r is the resistance, A is the area of membrane, l is the thickness (we use 1 mm in this calculation), and σ is the conductivity. When further considering the interfacial resistance in cathode and anode, the internal resistance in ASLBs far exceeds the maximum limit of 40 Ωcm² proposed by Randau et al.^{[8]}. Therefore, to achieve cell-level high energy density and efficiency for practical application, the SE membrane must simultaneously possess a low thickness and high ionic conductivity.^{[10]} However, when reducing the thickness, the obtained membrane becomes brittle, which creates new challenges in both SE membrane fabrication and cell stability, like the short circuit of the ASLBs. It is challenging to fabricate a SE membrane with robust mechanical strength and a thin thickness (<50 μm).

Embedding sulfide SEs into a template and the binder-assisted methods, including solution casting and dry film fabrication, are the two most reported processes to fabricate thin SE membranes.^{[6]} However, the ionic conductivities of the obtained membranes are generally reduced dramatically.^{[11]} The template method is challenged by the ionic insulation of the template and insufficient infiltration of SE, which causes interrupted ion conduction paths and cavities, resulting in lower ionic conductivity. The chosen binders are critical to the membrane's ionic conductivity and mechanical strength for the binder-assisted methods. Meanwhile, considering the sulfide SEs are chemically unstable in polar solvents, the binders selected would ideally be soluble in nonpolar solvents, which is difficult for most binders. Conventional binders-solvents systems, like polyvinylidene fluoride (PVDF) in N-methyl-2-pyrrolidone (NMP), sodium carboxymethyl cellulose-styrene butadiene rubber (CMC-SBR) in water, polyacrylic latex in water, are not suitable for sulfide SE membrane fabrication. Owing to the good solubility in nonpolar xylene and considerable binding effect, rubbers, like SBR, silicon rubber (SR), and nitrile butadiene rubber (NBR), have enabled the fabrication of thin membranes with low thicknesses through a slurry coating approach.^{[12]} However, the ionic conductivities are not satisfactory (<1 mS cm⁻¹) because the rubbers wrap the ionic conductive ceramic powders and block the ion conduction paths. It is thus of great importance to developing advanced binders and binding strategies to fabricate ultrathin, robust, and highly ion-conductive membranes.

In this work, for the first time, ethyl cellulose was employed as a disperser and binder during electrolyte suspension preparation and SE membrane fabrication. Cellulose is the most abundant biopolymer on the earth.^{[13]} Ethyl cellulose is a derivative of cellulose through an etherification reaction, through which a certain amount of hydrophilic hydroxyl groups are converted into hydrophobic ethyl groups.^{[14]} The resultant ethyl cellulose shows unique properties, including excellent solubility in nonpolar organic solvents, excellent dispersing capability, outstanding film formability, and high binding strength. All of these properties enable ethyl cellulose in applications such as food packaging, drug delivery, and emulsion fabrication.^{[14, 15]} The high mechanical tensile strength of 47-72 MPa of ethyl cellulose benefits to the robustness when compositing with other materials.^{[16]} Inspired by these merits, we utilized ethyl cellulose to prepare the thin SE membrane. As a result, a freestanding, ultrathin, robust, and highly ion-conductive sulfide SE membrane was successfully fabricated based on the argyrodite Li₆PS₅Cl electrolyte through point-to-point gluing. Through a scalable vacuum filtration process, the thickness of the membrane was well controlled. In addition, we also investigated the excellent chemical and electrochemical compatibility of ethyl cellulose with both Li₆PS₅Cl and toluene. More importantly, the ethyl cellulose forms point contact with Li₆PS₅Cl particles instead of areal wrapping, which was investigated through X-ray computed tomography (XCT). Li₃InCl₆ is used as the ion conductor in the cathode layer due to its high stability with LiCoO₂ and Li₆PS₅Cl. The ASLB produced by coupling this advanced SE and stabilized cathode displayed a high cell-level energy density for practical applications.

The stabilization of cathode in all-solid-state lithium batteries (ASLBs) is critical to achieve compatible performance with the commercial Li-ion batteries (LIBs) using liquid electrolytes. The ideal solid electrolytes (SEs) in the cathode layer are required with high ionic conductivity (>10-3 S cm-1), chemical stability with cathode, wide electrochemical stability window, and intimate contact with the cathode. Conventional superior ion-conduct SEs, like oxides and sulfides, are limited by the insufficient interface contact or severe interface reaction. An extra interface engineering is necessary to achieve a stable interface. However, the conventional approaches, like the atomic layer deposition (ALD) and chemical vapor deposition (CVD), are generally limited by high-cost facility; wet chemical coating and dry mixing are challenged by the unconformable coating. Both ALD and wet coating meet challenges for scalability in the industry. Meanwhile, the coating materials generally deliver low ionic conductivities (10-6˜10-9 S cm-1), which cause sluggish reaction kinetics.

An example embodiment successfully employs a halide, Li₃InCl₆, to achieve a stabilized cathode electrode and high-performance ASLBs with cell-level energy density. The approach is scalable and promising. Li₃InCl₆ is highlighted with outstanding ionic conductivity (>0.5 mS cm⁻¹) under high potential, good stability with high voltage cathodes (LiNi_{0.8}Mn_{0.1}Co_{0.1}O₂ and LiCoO₂), wide electrochemical stability window (>5 V vs. Li⁺/Li), and natural softness. More importantly, through a water-mediated synthesis approach, the mixing of halides with cathode is very uniform, accompanying with intimate contact. Compared with directly using oxides, sulfides, or aforementioned interface engineering approaches, methods described herein are facile, scalable, highly efficient, and promising for industrial use.

The cathode preparation is conducted through a water-mediated method. In detail, LiCl and InCl₃ powders in a stoichiometric ratio of 1:3 are sequentially dissolved in water, typically deionized water. After the powders are totally dissolved, cathode powder (such as LiCoO₂ and LiNi_{0.8}Mn_{0.1}Co_{0.1}O₂) is added into the solution and further dispersed under a bath sonication for 30 min. The weight ratios of cathode active materials to the mixture of LiCl and InCl₃ are adjusted from 80:20, 85:15, and 90:10. The dispersion is then placed in the oven to totally remove the water at 100° C. Subsequently, the obtained powder is treated at 200° C. for 6 h in a vacuum. To avoid contamination, the sample may be quickly transferred to a glovebox for further use.

The method of making a solid-state electrolyte by incorporating ethyl cellulose can be performed with many sulfide solid electrolytes. The examples described herein relate to Li₆PS₅Cl, but other sulfide solid electrolytes can be used. In some embodiments, the sulfide solid electrolyte is a lithium sulfide, such as Li₂S. In some embodiments, the sulfide solid electrolyte is a germanium sulfide, such as GeS₂. In some embodiments, the sulfide solid electrolyte is a lithium thio-phosphate, such as Li₃PS₄ or Li₇P₃S₁₁. The sulfide solid electrolyte can be doped with a variety of other atoms, such as germanium (e.g., Li₁₀GeP₂S₁₂) and silicon (e.g., Li₁₁Si₂PS₁₂).

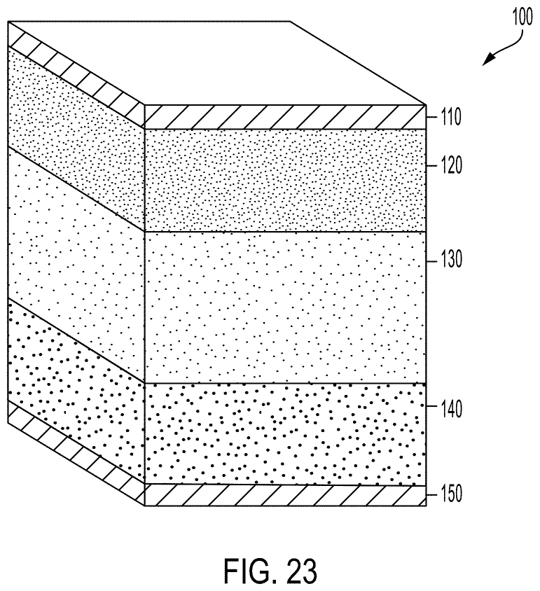

FIG. 23 is a schematic of an all-solid-state lithium battery (ASLB) 100. In general, ASLBs include a cathode current collector 110, a cathode 120, a solid-state electrolyte 130, an anode 140, and an anode collector 150.

### EXEMPLIFICATION

### Results and Discussion

To achieve high energy densities, it is essential to employ a thin SE membrane in the ASLB. Compared to the conventional cold press method, the binder-assisted solution method can efficiently fabricate a thin SE membrane, and it is scalable. However, the binder must meet the following requirements: 1) high compatibility with ceramic ion conductors and solvent; 2) excellent thermal stability during heating treatment to remove solvent; 3) superior mechanical binding strength.

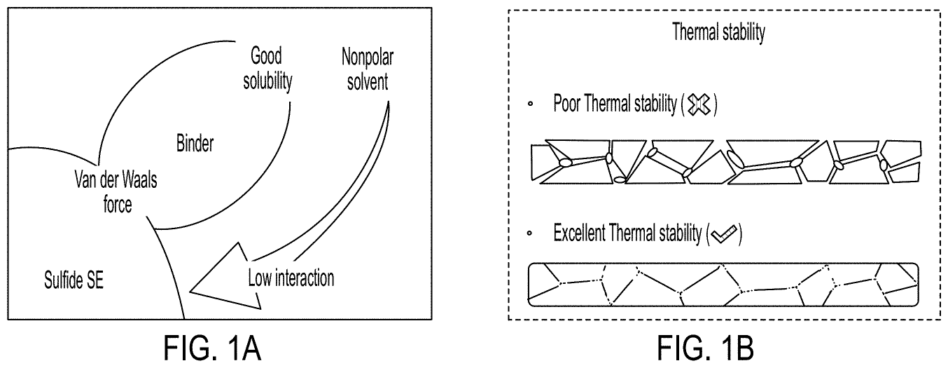

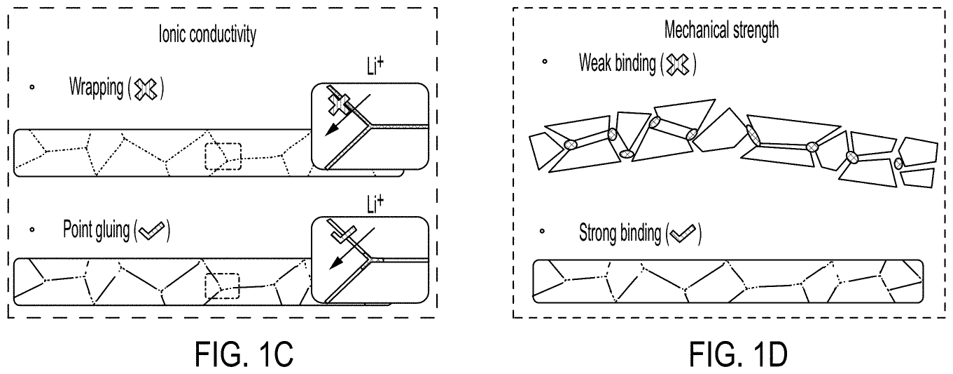

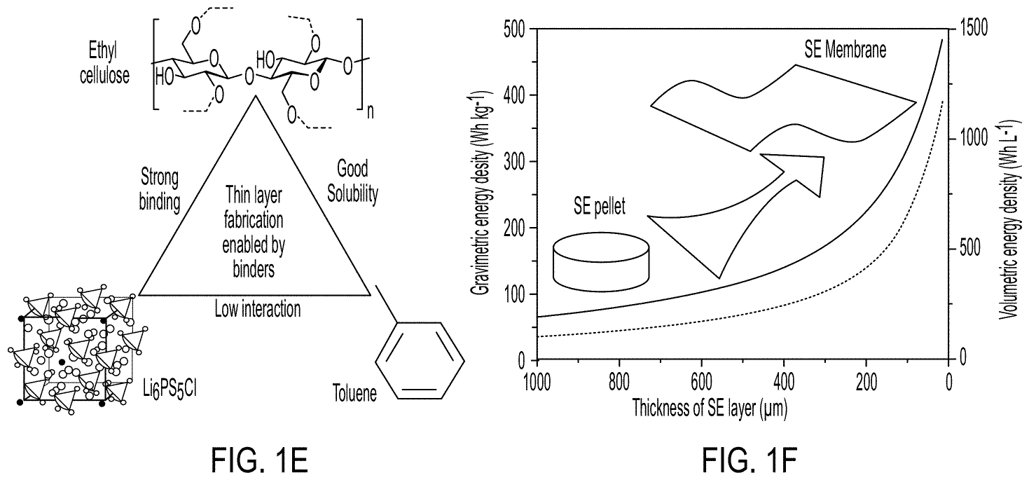

Excellent chemical stability between sulfide SE and solvent benefits the dispersion stability of ink, which is critical in fabricating a highly ion-conductive SE membrane. FIG. 1A illustrates the required compatibility among sulfide SE, binder, and solvent in the thin SE membrane fabrication through the solution method. As aforementioned, a nonpolar solvent is necessary to avoid the reaction with sulfide SE. Therefore, the binder should have good solubility in a nonpolar solvent to prepare a uniform and stable suspension.

Promising binder candidates should possess excellent solubility in nonpolar solvent, weak interaction with sulfide SE, remarkable thermal stability, and strong binding with sulfide SE through point gluing. FIG. 1B schematically describes the importance of the thermal stability of binder in thin film fabrication. Because an additional heating process (temperature >200° C.) was generally employed to remove the solvent in the membrane thoroughly, the binder would ideally have high thermal stability to maintain the structure and binding capability. The thermal degradation of binders at elevated temperatures causes cracks and defects in the membrane and ionic conductivity deterioration. Meanwhile, the distribution of the binder effectively impacts the membrane's ionic conductivity, as illustrated in FIG. 1C. Considering most of the binders are non-ion conductive, the binder may block the ion conduction if it completely wrapped the sulfide SE. The ideal protocol involves a point gluing that the binder is discretely distributed between sulfide SEs to guarantee continuous ion conduction paths. Therefore, it is important to minimize the binder amount to achieve the point gluing, which challenges the mechanical strength of the membrane. FIG. 1D depicts the effect of the binding ability of the binder on the mechanical strength of the membrane. The weak binding will cause poor mechanical strength and limit the application of a thin SE membrane. A strong binding can enhance the mechanical stability, especially with a low amount of binder.

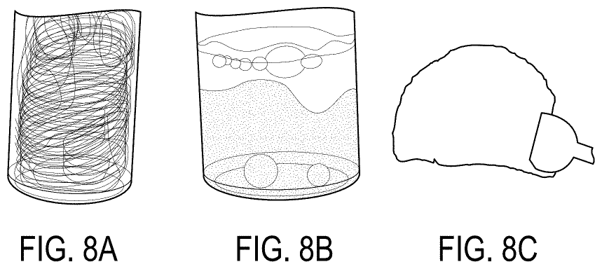

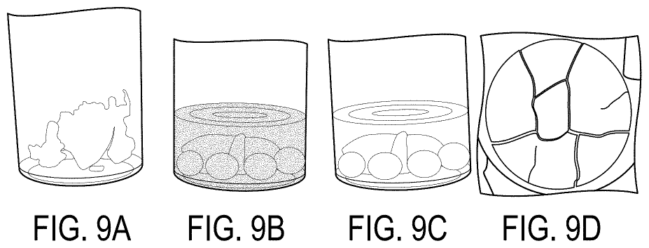

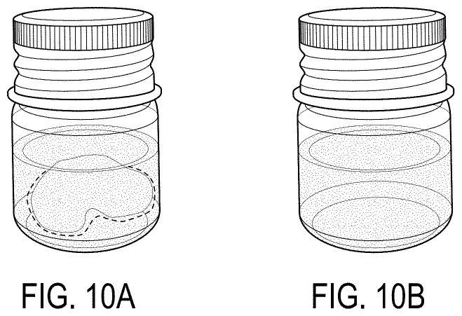

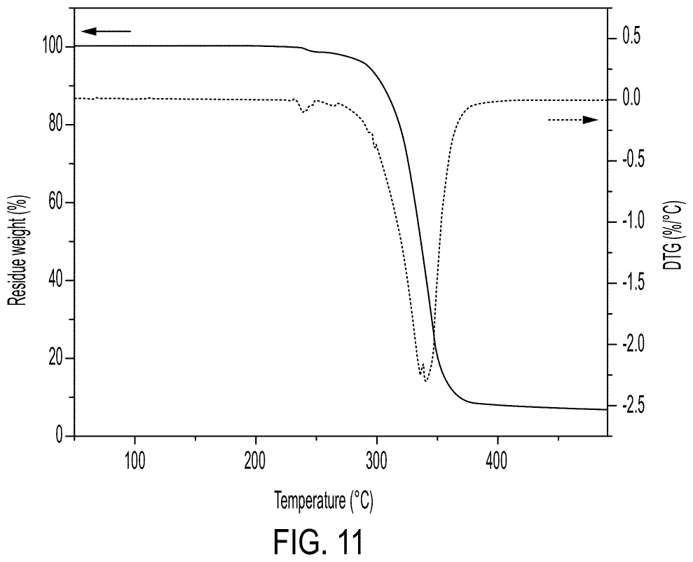

Different kinds of polymers were tested and screened in this work, including regular cellulose, 2,2,6,6-tetramethylpiperidine-1-oxyl (TEMPO) oxidized cellulose nanofiber grafted with Polyethylene glycol, and flax fiber, but all of them show poor film formability when compositing with Li₆PS₅Cl (FIGS. 8A-C and 9A-D). In contrast, ethyl cellulose with the hydrophobic ethyl groups has good solubility in toluene, as presented in FIGS. 10A-B. More importantly, the strong binding of ethyl cellulose can enable the thin membrane with considerable mechanical strength even at a low ratio (2 wt. %). In addition, owing to the ethyl cellulose's excellent thermal stability over 200° C. (as shown in FIG. 11), ethyl cellulose could survive in the high-temperature solvent removal process. Ultimately, ethyl cellulose was selected based on its excellent solubility, mechanical binding strength, and excellent thermal stability. FIG. 1E illustrates the compatibility among Li₆PS₅Cl, ethyl cellulose, and toluene in this process. Li₆PS₅Cl is a widely studied sulfide SE due to its outstanding ionic conductivity (˜1.6 mS cm⁻¹), facile synthesis, and low cost. Furthermore, Li₆PS₅Cl shows excellent stability when dispersed in toluene due to the low polarity of toluene (0.099 of relative polarity)^{[17]}, resulting in excellent compatibility and an intact ionic conductivity after treatment. Thus, the system using Li₆PS₅Cl, ethyl cellulose, and toluene enables the successful fabrication of a thin SE membrane owning high ionic conductivity and mechanical strength at the same time.

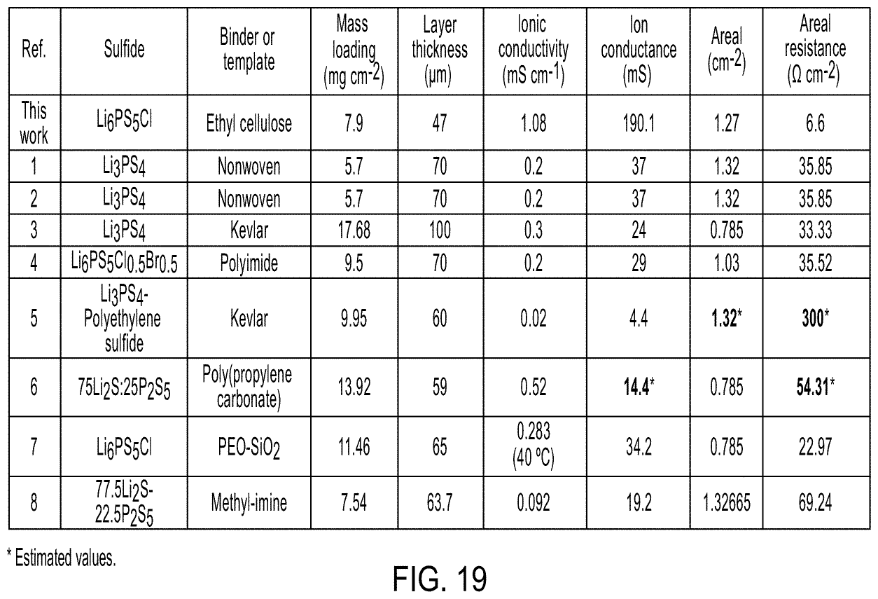

The employment of a thin SE membrane could significantly boost the energy densities of the ASLB. FIG. 1F displays the estimated cell-level gravimetric and volumetric energy densities (including cathode, anode, and electrolyte) as the factor of the thickness of the SE membrane in a typical sheet-type ASLB coupling LiCoO₂ and Li metal. The detailed information used for the estimation is listed in FIG. 19. As the SE membrane thickness varies from 1000 μm to 20 μm, both gravimetric and volumetric energy density are dramatically increased from 65 Wh kg⁻¹ and 106 Wh L⁻¹ to 484 Wh kg⁻¹ and 1174 Wh L⁻¹, respectively. Thus, compared to the SE pellet with high thickness, the thin SE membrane contributes a lightweight and higher energy density and a reduced internal resistance resulting in enhanced energy storage efficiency in ASLBs.

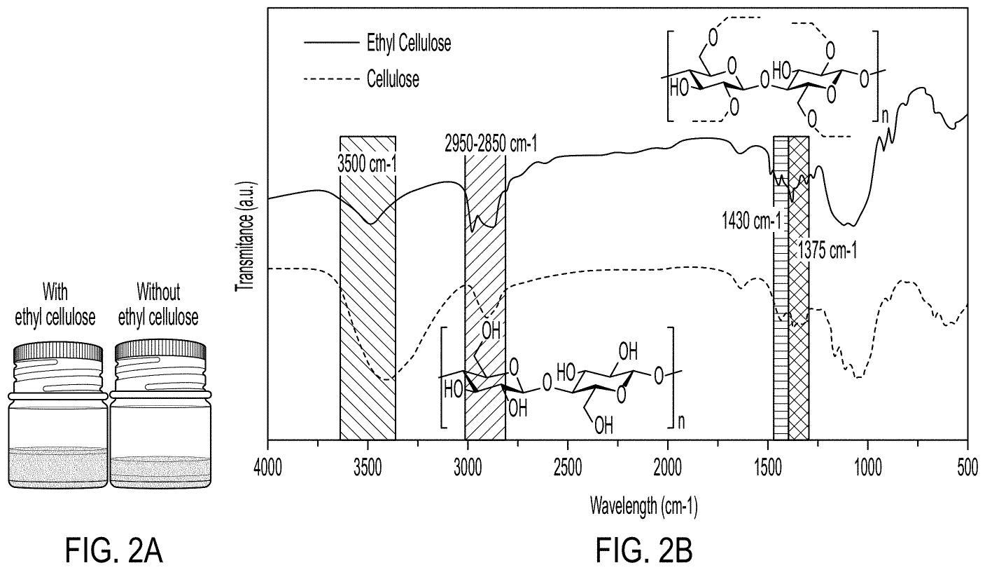

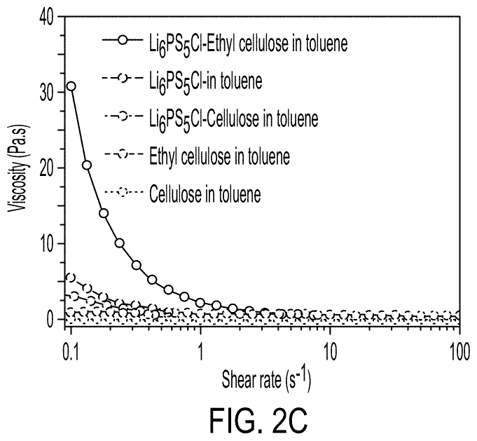

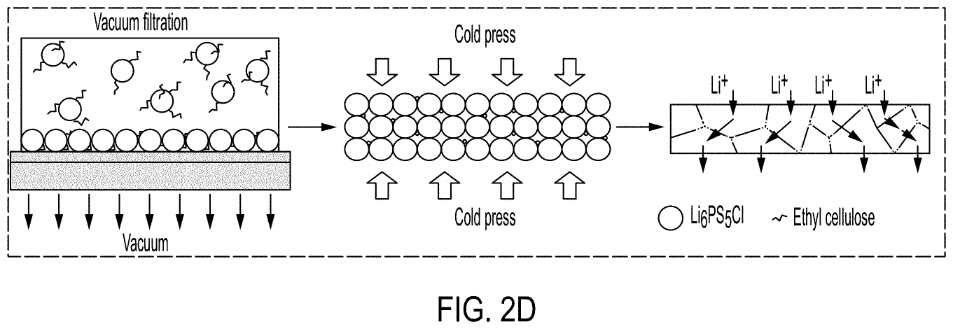

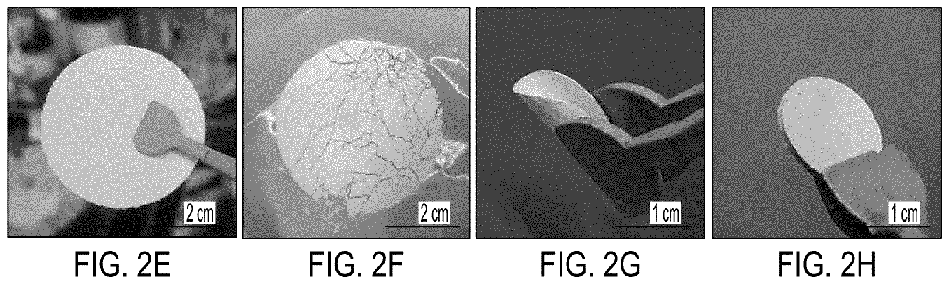

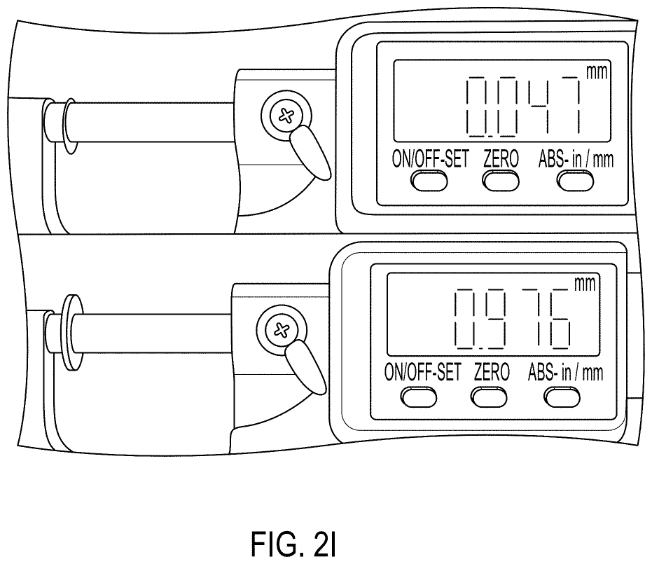

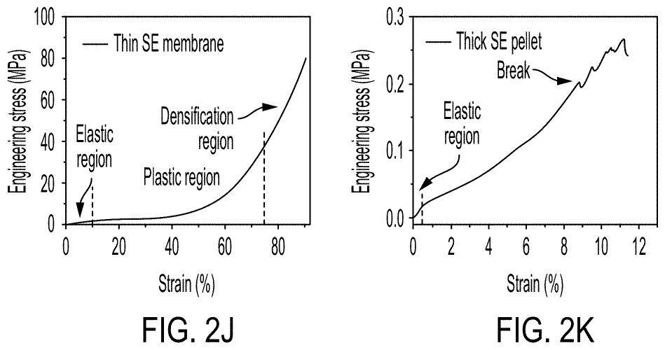

The unique amphipathic molecular structure of ethyl cellulose enables the fabrication of a thin and robust membrane. FIG. 2A shows the dispersions of Li₆PS₅Cl in toluene with and without ethyl cellulose after standing for one hour. The Li₆PS₅Cl is uniformly dispersed in toluene with the addition of 2.0 wt. % ethyl cellulose. In contrast, there are apparent precipitations in the sample with no ethyl cellulose but only Li₆PS₅Cl. The enhanced dispersion stability is highly related to the amphipathic molecular structure of ethyl cellulose. Compared with conventional cellulose, ethyl cellulose has partially substituted hydroxyl groups by ethyl groups (FIG. 2B). As shown in attenuated total reflection Fourier-transform infrared spectroscopy (ATR-FTIR), cellulose had a well-defined peak centered at around 3500 cm⁻¹, attributed to its abundant hydroxyl groups. However, the peak at this wavenumber is much weaker for ethyl cellulose since the ethyl groups substituted the hydroxyl groups (degree of substitution was at 2.5). This substitution is also evidenced by the weaker peak of ethyl cellulose at 1430 cm⁻¹ than that of cellulose, assigned to in-plane bending of —OH in the glucose unit. In the meantime, the peak at 1375 cm⁻¹ assigned to —CH₃ bending presents for ethyl cellulose other than cellulose, attributed to the methyl end groups in the ethyl moieties of ethyl cellulose. We also found an asymmetric peak at around 2950-2850 cm⁻¹ for ethyl cellulose, assigned to —CH stretching as reported.^{[18]} The hydrophobic branches enable ethyl cellulose its outstanding solubility in toluene.

To further evaluate the dispersion uniformity and interaction of Li₆PS₅Cl with ethyl cellulose in toluene, the viscosities of cellulose, ethyl cellulose, Li₆PS₅Cl, Li₆PS₅Cl-cellulose, and Li₆PS₅Cl-ethyl cellulose, are compared in FIG. 2C. The dispersion of Li₆PS₅Cl-ethyl cellulose shows significantly higher viscosity than that of single components, suggesting excellent bonding exists between Li₆PS₅Cl and ethyl cellulose. Ethyl cellulose owns a negative charge on the surface derived from the remaining hydroxyl groups.^{[19]} Meanwhile, the phosphorus and Li ions in Li₆PS₅Cl act as electron acceptors to interact with ethyl cellulose and generate bonding.^{[20]} This bonding helps the stable dispersion of Li₆PS₅Cl in toluene but is not strong enough to cause the degradation of Li₆PS₅Cl.

After preparing the well-dispersed Li₆PS₅Cl suspension, a vacuum filtration process was applied to fabricate a thin membrane, as shown in FIG. 2D. In addition to the abovementioned bonding, ethyl cellulose also exhibits a strong binding effect with Li₆PS₅Cl enabling the SE membrane to be peeled off from the filter paper after filtration. The obtained freestanding membrane was further cold-pressed into an ultrathin and dense layer for future use. In addition, ethyl cellulose provides particular mechanical strength through point gluing other than completely wrapping. As a result, the ion conduction paths in the thin SE membrane can remain continuous without interruption by the binder (in other words, the ethyl cellulose does not block ion conductance paths). Therefore, the thin membrane simultaneously achieves an intact ionic conductivity and considerable mechanical robustness simultaneously.

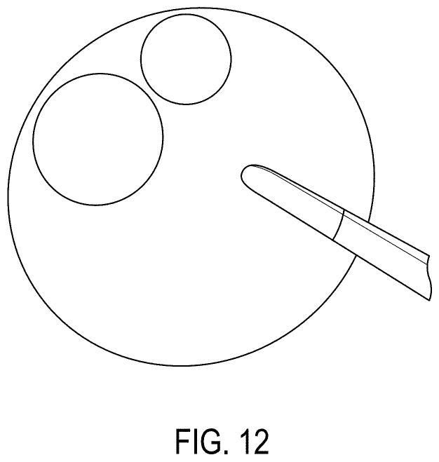

FIG. 2E displays the as-prepared freestanding SE membrane. There are no cracks after the membrane being peeled off from the filter paper. In contrast to the conventional SE pellet with a diameter lower than 1.3 cm, the SE membrane owns a diameter of 44 mm. Employing a larger filtration setup can further scale up the sample size. For comparison, the sample prepared with the same process but without ethyl cellulose shows poor film formability where the membrane pulverizes after removing the solvent (FIG. 2F). The SE membrane can be further punched into smaller sizes without fracturing, as shown in FIG. 12, suggesting outstanding robustness. The as-punched SE membrane with a diameter of 1.27 cm also shows considerable flexibility, as shown in FIG. 2G, benefiting the following ASLB fabrication process. The areal weight of the SE membrane was as low as 7.9 mg cm⁻². FIG. 2H shows the conventional SE pellet prepared through the cold press. The areal weight is as high as 158.7 mg cm⁻², 20 times higher loading compared to the thin SE membrane. The thickness of the SE membrane before pressing is 180 After pressing at 300 MPa, the thickness decreases to 47 μm (FIG. 2I). In comparison, a regular SE pellet exhibits a much higher thickness of 976 μm.

Considering the SE membrane generally experiences a high pressure in ASLB, robustness under compression is necessary to avoid mechanical failure. FIG. 2J displays the stress-strain profile of a thin SE membrane in an axial compression process. It suggests that the thin SE membrane experiences three stages: elastic deformation, plastic deformation, and densification, similar to the behavior of the porous wood sample (Aimene et al.).^{[21]} The SE membrane does not show fracturing even at a high compression stress of 80 MPa, although a high deformation is observed (90% reduction in thickness). In contrast, the thick SE pellet shows an obvious fracture point at a low stress of 0.27 MPa (FIG. 2K). Overall, the introduction of ethyl cellulose significantly improves the membrane robustness in the compression process attributing to the strong binding ability of ethyl cellulose with Li₆PS₅Cl.

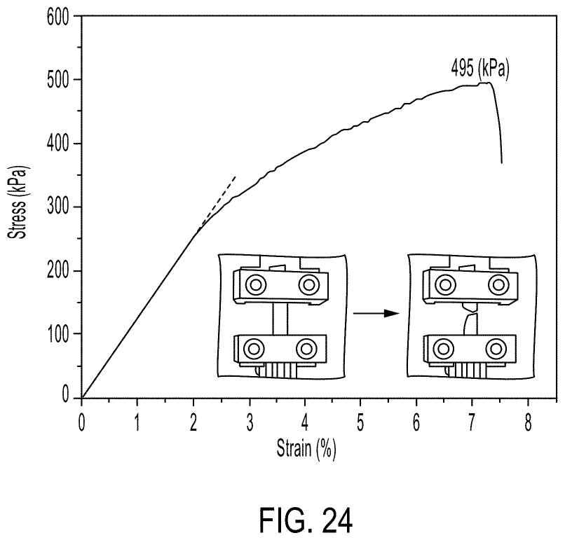

The tensile strength of the thin SE membrane is also investigated, as shown in FIG. 24. The thin SE membrane shows a high tensile strength of 495 kPa and a high Young's modulus of 12.56 MPa. The excellent mechanical strength demonstrates that the thin SE membrane has good processibility in fabricating ASLBs.

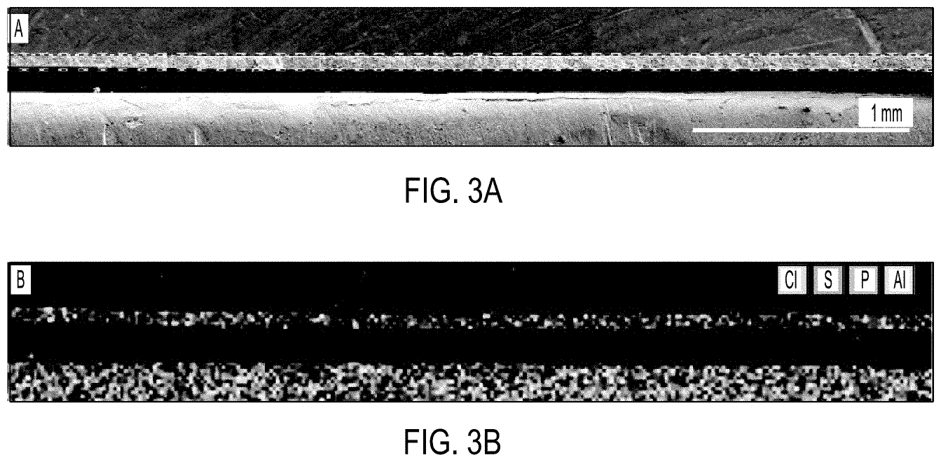

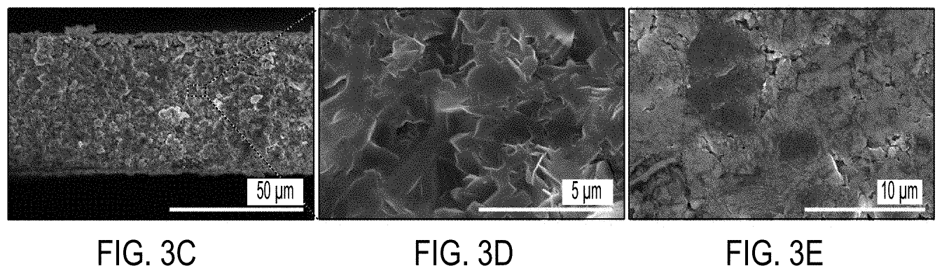

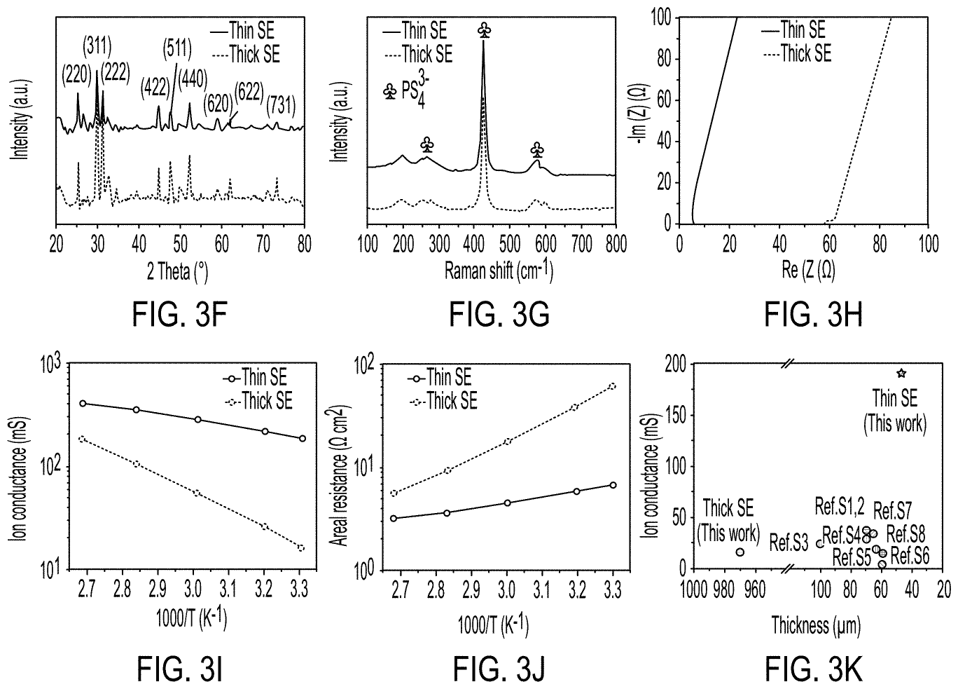

FIG. 3A displays the cross-section scanning electron microscopy (SEM) image of the freestanding thin SE membrane. As highlighted by the yellow dash lines, the membrane shows a uniform thickness of around 50 μm, and no apparent voids or cracks are observed. The energy dispersive X-ray spectroscopy (EDS) mapping in FIG. 3B confirms the homogeneously distributed Cl, S, and P elements from Li₆PS₅Cl. In the magnified images in FIGS. 3C-D, the Li₆PS₅Cl particles with a size smaller than 3 μm are closely stacked together to form a dense membrane. The ethyl cellulose is not visible on the surface or interface between Li₆PS₅Cl particles, which avoids the ion conduction block caused by the ethyl cellulose wraps the Li₆PS₅Cl particles. FIG. 3E shows the top view of the membrane where there are no apparent voids or cracks. The uniform thickness and homogeneous distribution originate from the highly stable dispersion of Li₆PS₅Cl-ethyl cellulose in toluene and the efficient solvent removal in the vacuum filtration process.

As aforementioned, the Li₆PS₅Cl is highly sensitive to many polar solvents and binders. Herein the stabilities of Li₆PS₅Cl against toluene and ethyl cellulose were investigated. FIG. 3F compares XRD patterns of a thin SE membrane prepared with ethyl cellulose in toluene through wet filtration and a thick SE pallet without ethyl cellulose fabricated with dry pressing in the range from 20° to 80°. There are no newborn peaks and peak position shifts observed in thin SE compared with thick SE, indicating excellent compatibility between Li₆PS₅Cl with ethyl cellulose and toluene. All the patterns are indexed to the typical argyrodite (cubic space group: F-43m). The prominent diffraction peaks at 25.5°, 30.0°, 31.4°, 45.0°, 47.9°, and 52.4° are indexed to (220), (311), (222), (422), (511), and (440) planes, respectively.^{[22]} The Raman spectra of both thin SE and thick SE are displayed in FIG. 3G to confirm that the fabrication process has no damage to Li₆PS₅Cl. The peaks located at 195.9, 263.3, 426.7, 577.8, and 600.5 cm⁻¹ are attributed to the tetrahedral PS₄³⁻ unit in argyrodite-type Li₆PS₅Cl.^{[23]} As a result, the membrane fabrication process shows the marginal side effect on Li₆PS₅Cl, which is necessary for achieving high ionic conductivity.

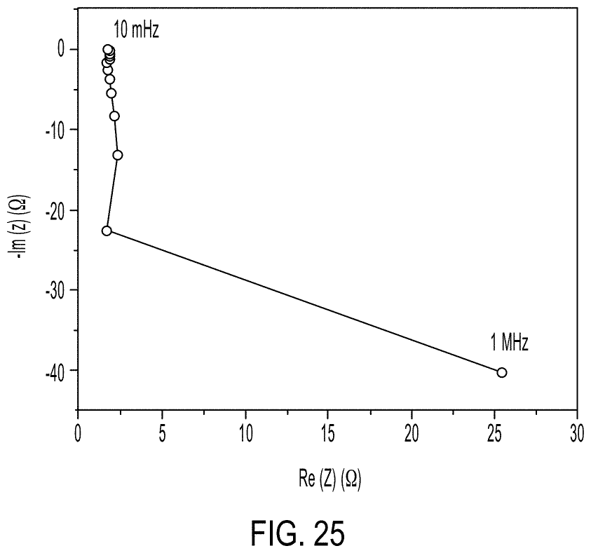

The ionic conductivities of the thin SE and thick SE were evaluated through an AC impedance measurement in a symmetric cell with ion-blocking electrodes. FIG. 3H compares the amplified Nyquist plots of thin SE and thick SE at high and mid frequencies at 30° C. The thin SE and thick SE thicknesses used in the measurement are 52 and 970 μm, respectively. Both SEs exhibited a typical diagram of sulfide superconductors where the plots are mainly a straight line demonstrating superior ionic conductivity. Neglecting the resistance from the external circuit, the overall ionic resistance of the SE is the sum of the bulk resistance, grain boundary resistance, and external resistance. The external resistance stemming from the outer wires and packages of the cell is measured as 1.83Ω and subtracted in the ion conductivity evaluation (FIG. 25). Impressively, the thin SE had an ultralow resistance of 5.26Ω and high ionic conductivity of 1.08 mS cm⁻¹, comparable to the intrinsic ionic conductivity of Li₆PS₅Cl. More importantly, the derived ion conductance is as high as 190.11 mS, representing the highest value reported so far. In contrast, the thick SE exhibits a much higher resistance of 62.20Ω. Though the ionic conductivity is as high as 1.61 mS cm⁻¹, the ion conductance is only 16.07 mS. Therefore, a tenfold increase in ion conductance is achieved by reducing the thickness of the SE.

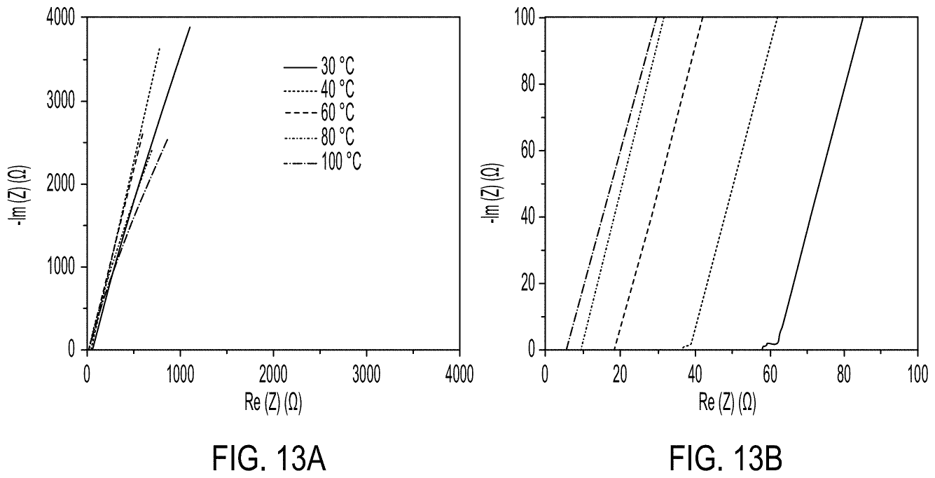

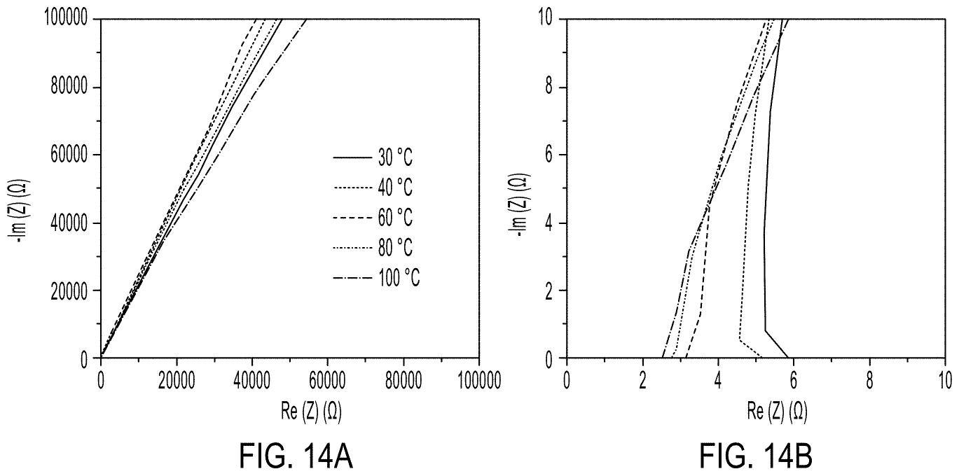

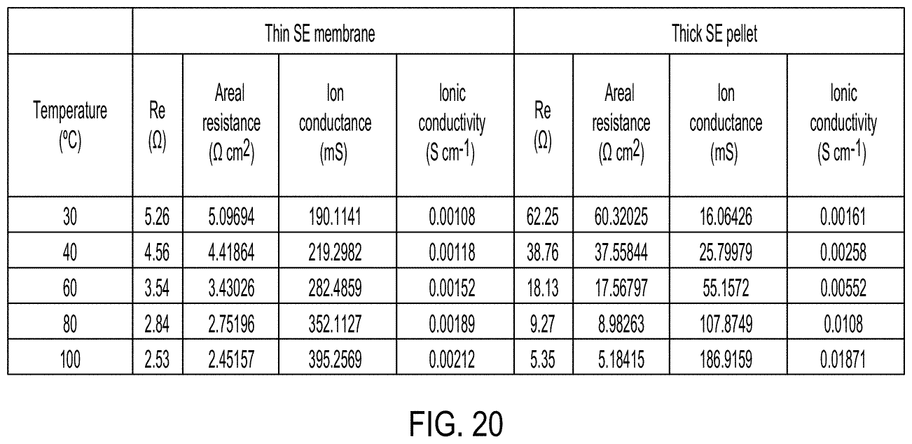

The ion conductions of thin and thick SEs at various temperatures (from 30° C. to 100° C.) were investigated (details in FIG. 19). The temperature affects the ionic conductivity, which is related to the activation energy of SEs. As shown in FIGS. 13A-B and 14A-B, the plots shift to the left at higher temperatures indicating enhanced ion conduction. FIG. 3I compares the temperature-dependent ion conductance of thin and thick SEs. The ion conductance of thick SE varies more than that of thin SE as temperature increased. There is an increase of over 11-fold from 16.07 to 181.23 mS in ion conductance of thick SE, attributed to an activation energy of 0.365 eV. In contrast, the thin SE deliveres a slight increase in ion conductance from 190.11 mS to 395.26 mS, resulting in an activation energy of 0.135 eV. The significant decrease in activation energy may be because the external resistance in the calculation is not negligible when the internal resistance reaches a low value. Notably, the ion conductance of thin SE at 30° C. (190.11 mS as mentioned above) is even higher than that of thick SE at 100° C. (186.92 mS), although the ionic conductivity of thin SE is much lower than that of thick SE (1.08 mS cm⁻¹ at 30° C. for thin SE and 18.71 mS cm⁻¹ at 100° C. for thick SE). The dramatically enhanced ion conductance was contributed to the significantly reduced thickness (from 970 μm to 50 μm) and only very slightly sacrificed ionic conductivity (from 1.61 mS cm⁻¹ to 1.08 mS cm⁻¹). Moreover, to have a normalized comparison, the areal resistances of thin and thick SEs were evaluated, as displayed in FIG. 3J. The thin SE has an ultralow areal resistance of 5.10 Ωcm² at 30° C., while the thick SE exhibits a much higher value of 60.32 Ωcm². Excluding the charge transfer resistances, the thin SE is very promising to enable the ASLB with an internal resistance lower than the demanded 40 Ωcm². FIG. 3K compares the ion conductance of SE membranes in this work with other reported values (details in FIG. 20). This thin SE membrane has the highest ion conductance among various thin-film SEs.

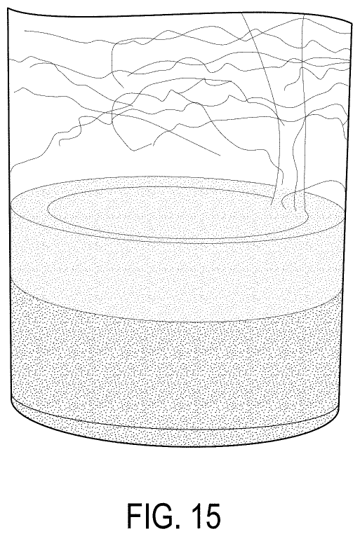

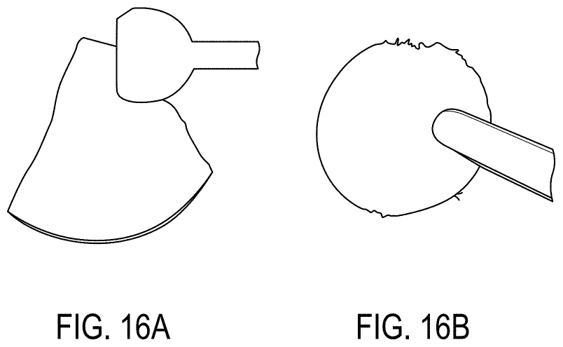

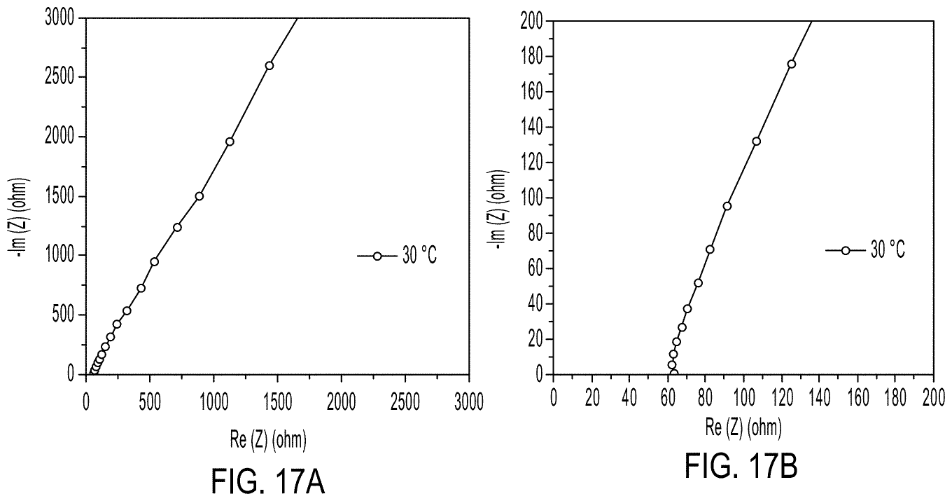

To further highlight the significance of ethyl cellulose, we prepared the thin film using regular cellulose as a binder through the same processes. Due to the richness in hydrophilic hydroxyl groups, regular cellulose exhibits poor dispersion in toluene even after a mechanical pulverization. The dispersion of Li₆PS₅Cl and cellulose quickly precipitates after standing for one minute (FIG. 15). After filtration, the samples with a cellulose ratio lower than 10 wt. % showed poor film formability, attributed to the poor binding effect between cellulose and Li₆PS₅Cl. We then obtained a freestanding membrane with 10 wt. % of cellulose, and it broke into pieces when peeled off from the filter paper due to poor mechanical strength (FIGS. 16A-B). An incomplete circular membrane with a low thickness of 64 μm was fabricated after cold pressed at 300 MPa. The ionic conductivity was only 0.12 mS cm⁻¹, which agreed well with that of other fiber-reinforced thin SE membrane prepared by cold pressing (FIGS. 17A-B).^{[24]} In this sample, because of poor binding with Li₆PS₅Cl, fibrous cellulose acted as the building blocks but not as a binder in film fabrication. A high fraction of cellulose fibers was desired to maintain a good mechanical strength but may block the ion conduction in the membrane and reduce the ionic conductivity.

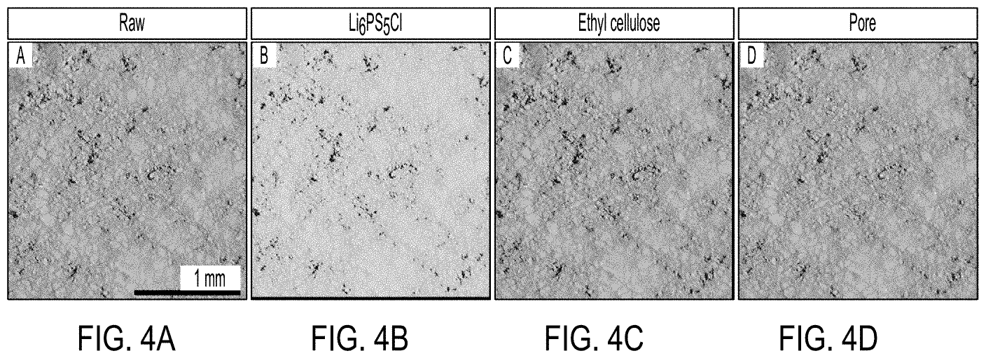

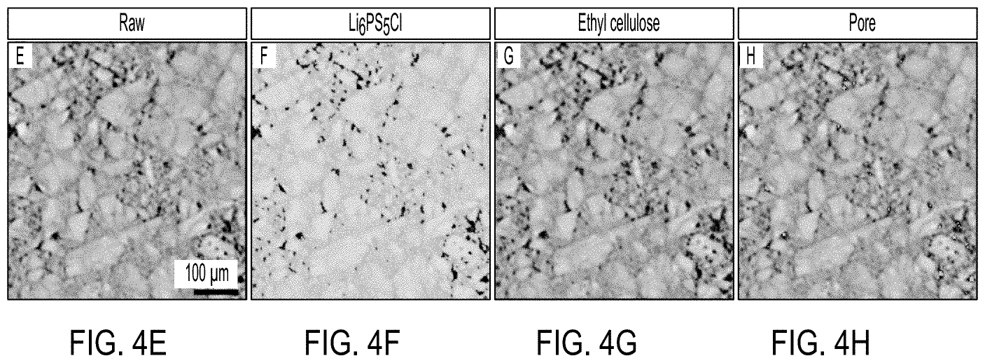

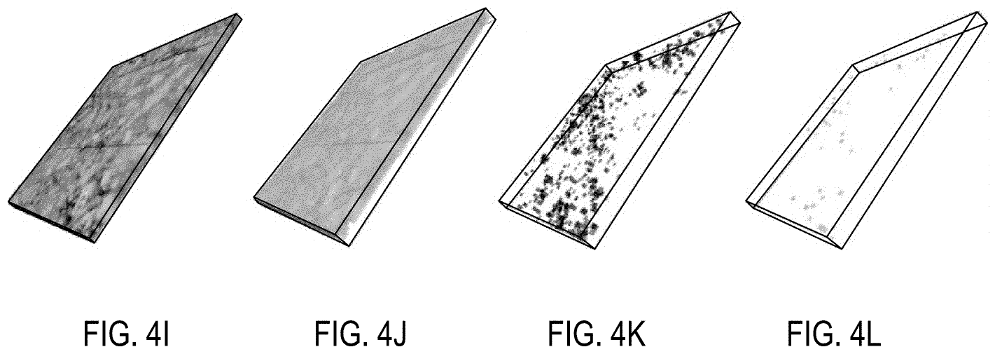

The ion conduction pathways are significantly determined by the distributions of Li₆PS₅Cl, ethyl cellulose, and pores. Therefore the XCT is employed to study the distribution of Li₆PS₅Cl, ethyl cellulose, and pores. Unlike SEM, which only provides surface information, XCT is a powerful technique to probe internal structure and generate three-dimensional reconstructions based on the segmental scans.^{[25]} FIG. 4A shows the 2D image of the thin SE membrane from the top view. There are obvious grey level contrasts in different regions because of the density differences of the compositions. The bright region represents the Li₆PS₅Cl which is heaviest, and the dark grey region is attributed to ethyl cellulose which is relatively lighter, and the black spots are the pores. FIG. 4B highlights the distribution of Li₆PS₅Cl with yellow color. Notably, Li₆PS₅Cl takes the main fraction of the thin SE membrane and forms an integrated region, which benefits the ion conduction. The regions with red color in FIG. 4C correspond to the ethyl cellulose which scatteringly distributes in the SE membrane and doesn't form continuous wrapping demonstrating the point gluing with Li₆PS₅Cl. There are also pores detected in the thin membrane, labeled as blue in FIG. 4D. It is interesting that pore locations are accompanied with the ethyl cellulose regions. To further study the point gluing effect of ethyl cellulose, FIG. 4E displays the magnified 2D image of the SE membrane. It is clear that the Li₆PS₅Cl shows two different grey levels agreeing with the previous results. The particle size in the bright region is much larger than that in grey region. The loose packing of the small particles could result in a lower X-ray absorption delivering a grey color. In FIG. 4F, the Li₆PS₅Cl owns a high calculated volume fraction of 96.986 vol. % and shows continuous connections evidencing the high ionic conductivity. FIG. 4G highlights the distribution of ethyl cellulose further proving the point gluing. Obviously, the ethyl cellulose randomly distributes at the boundaries of Li₆PS₅Cl particles but not fully wrapping the Li₆PS₅Cl particles contributing to less barrier and more continuous ion transport paths. The volume fraction of ethyl cellulose is 2.92 vol. %. In FIG. 4H, there are also pores observed, and the volume fraction is as low as 0.094 vol. %. The pores generation is inevitable in solid electrolyte membrane, and the porosity can reach 23% in the cold-pressed pellet using Li₆PS₅Cl powders under the pressure of 370 MPa.^{[27]} Therefore, the addition of ethyl cellulose enables the thin SE membrane with lower pores benefiting the ion conductions. Furthermore, FIG. 4I displays the 3D segmented image of a 300×300×50 μm subvolume of the thin SE membrane. No huge cracks or voids are observed in the cross section. In the 3D segmented rendering of Li₆PS₅Cl (FIG. 4J), it is clear that the dense SE membrane is mostly occupied by Li₆PS₅Cl, suggesting the continuous ion conduction across the membrane. FIG. 4K illustrates 3D segmented rendering of ethyl cellulose which exists as the point and scatteringly distributed in this subvolume, evidencing the point gluing effect. In FIG. 4L, there are also sporadic pores observed, demonstrating the thin SE membrane owning high density.

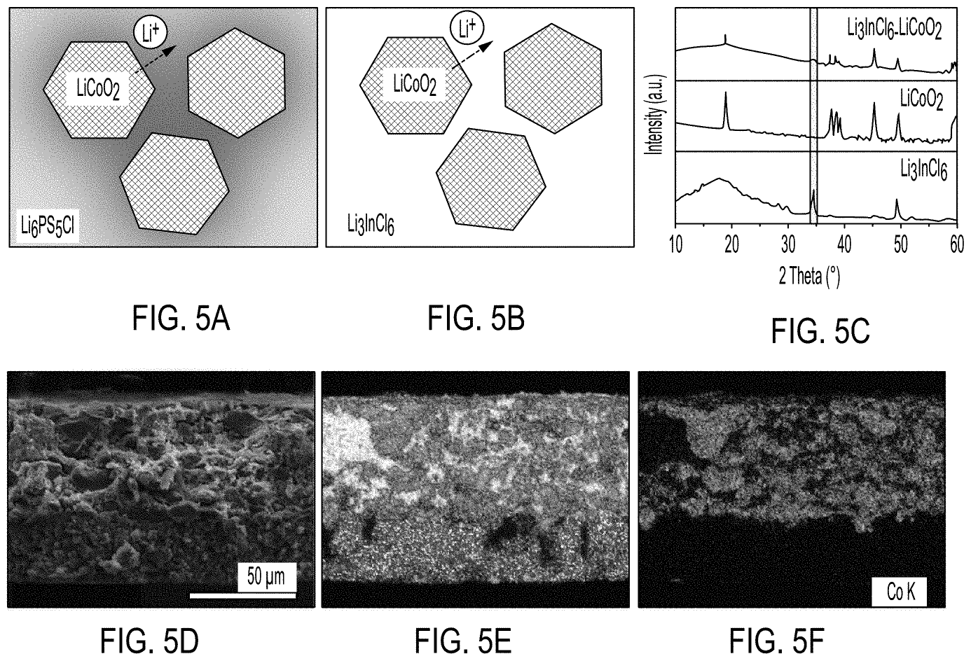

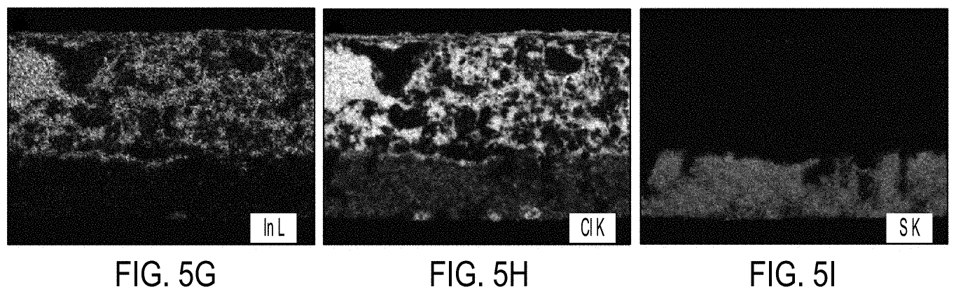

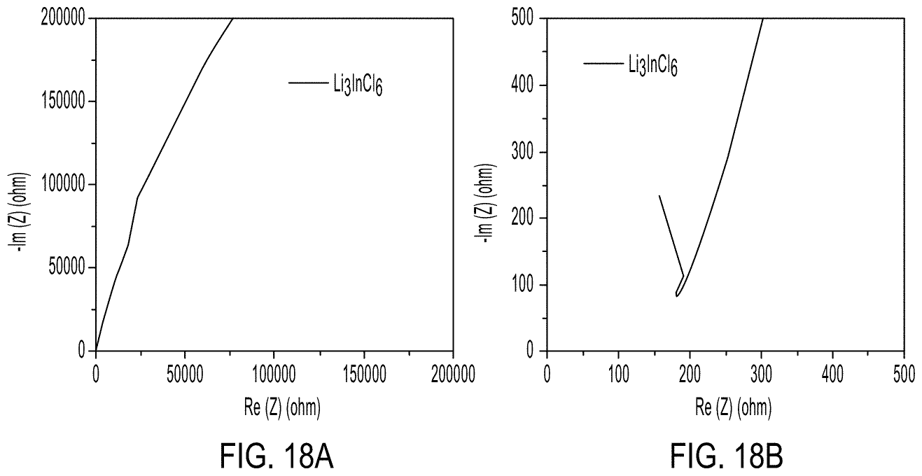

In ASLBs, the cathode layer plays an equally significant role with the thin SE in boosting the energy density. Generally, the cathode layer comprises of active material, SEs, and other components like carbon additives and binders. Benefiting from the high working voltage (>3.9 V), impressive capacity (>200 mAh g⁻¹), and considerable electron conductivity (˜10⁻⁵ S cm⁻¹), lithium cobalt oxide (LiCoO₂) has attracted numerous attentions.^{[28]} However, sulfide SEs suffer from poor stability with LCO, resulting in an interface passivation layer formation with sluggish ion conduction, as illustrated in FIG. 5A. Surface coating layers, such as LiNbO₃ and Li_{0.35}La_{0.5}Sr_{0.05}TiO₃, have been reported to stabilize the interface between sulfide SEs and oxide cathodes.^{[23, 29]} However, the commonly relatively low ionic conductivity (10⁻⁹ to 10⁻⁶ S cm⁻¹) of coating material rendered a new interface resistance. The high cost also constricts the large-scale application. Meanwhile, it is challenging to coat a uniform and thin layer with scalable methods for industrial application. A halide supertonic conductor, Li₃InCl₆, was employed as the SE in the cathode layer to address this challenge. The as-prepared Li₃InCl₆ shows an ionic conductivity of 0.4 mS cm⁻¹ (FIG. 18A-B). The Li₃InCl₆ was reported with high oxidation potential (up to 6.0 V), excellent chemical stability against LiCoO₂, and natural softness to achieve intimate contact with LiCoO₂.^{[30]} As depicted in FIG. 5B, a stable interface with fast ion transfer is formed without additional interface coating. The LiCoO₂—Li₃InCl₆ mixture was prepared through a facile water-mediated process.^{[31]} FIG. 5C compares the XRD spectra of the LiCoO₂—Li₃InCl₆ composites with that of pure LiCoO₂ and Li₃InCl₆. Most of the peaks are attributed to LiCoO₂, besides the highlighted one indexed to the Li₃InCl₆. No extra peaks appear, suggesting excellent compatibility between LiCoO₂ and Li₃InCl₆.

In the ASLB fabrication process, the as-prepared cathode powders were further ground and pressed into the thin SE membrane. The mass loading of active material (LiCoO₂) is 15.9 mg cm⁻². The weight ratio of LiCoO₂ to Li₃InCl₆ is 80:20. FIGS. 5D-I display the cross-section SEM images and the corresponding EDS element mappings (Co, In, Cl, and S) of the pressed SE-cathode layers, respectively. The cathode layer has a thickness of 55 μm where LiCoO₂ particles are uniformly mixed with Li₃InCl₆.

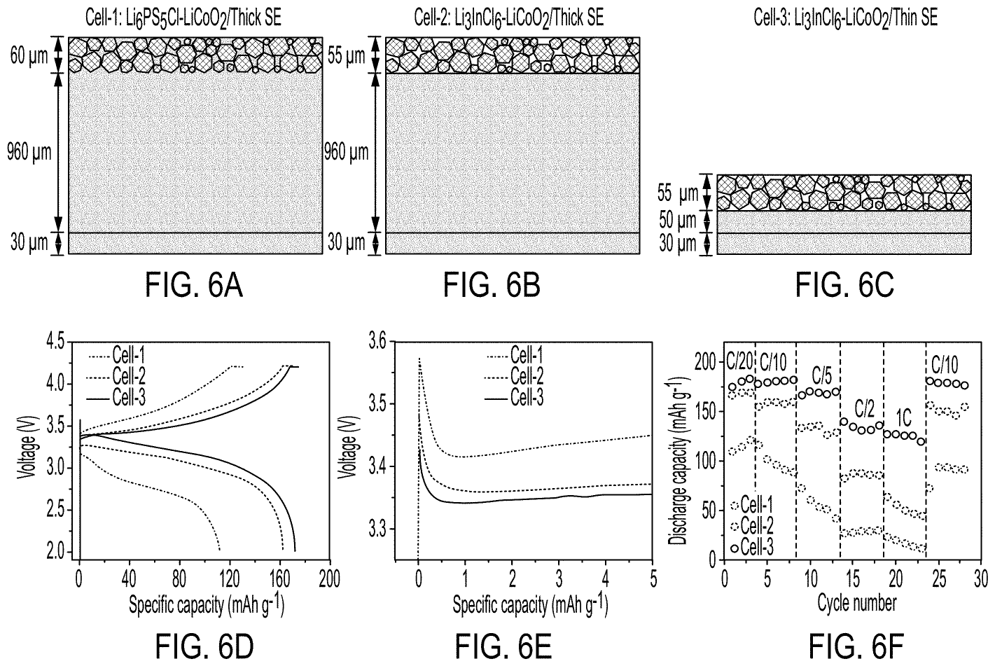

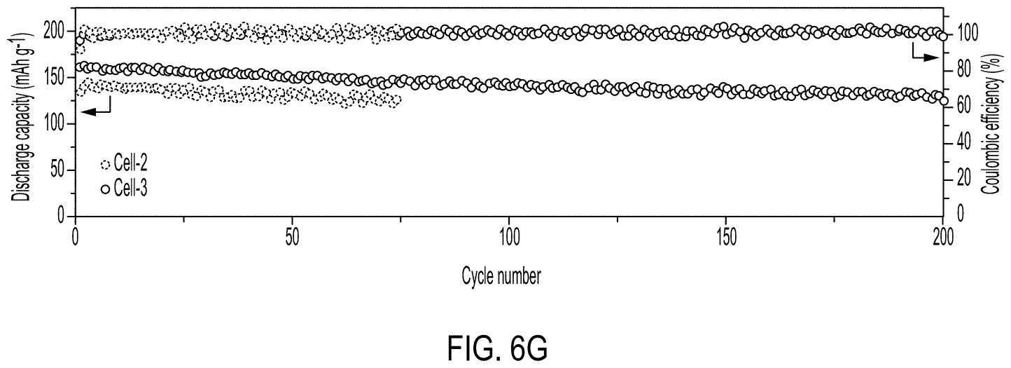

We further evaluated the effects of replacing sulfide with halide in the cathode layer and reducing the thickness of the SE layer in the ASLBs. As depicted in FIGS. 6A-C, three cells coupling LiCoO₂—Li₆PS₅Cl with thick SE (cell-1), LiCoO₂—Li₃InCl₆ with thick SE (cell-2), and LiCoO₂—Li₃InCl₆ with thin SE (cell-3) were assembled. The mass loading of the whole cathode and active material (LiCoO₂) were 19.84 and 15.87 mg cm⁻², respectively. To avoid the side effect caused by the anode side, In—Li acted as anode material in all three cells. All three cells were tested with a constant current/constant voltage protocol between 2.0 and 4.2 V (vs. In—Li). FIG. 6D displays the charge/discharge profiles of three cells at the current rate of C/20. Impressively, cell-3 (using thin SE and LiCoO₂—Li₃InCl₆ cathode) has the highest discharge capacity of 172 mAh g⁻¹ and initial coulombic efficiency of 98.3%. In comparison, cell-2 (using thick SE and LiCoO₂—Li₃InCl₆ cathode) has a discharge capacity of 163 mAh g⁻¹ and initial coulombic efficiency of 95.9%. The enhanced cell capacity and coulombic efficiency result from the reduced internal resistance derived from the layer thickness reduction. Meanwhile, it is not surprising that cell-1 (using thick SE and LiCoO₂—Li₆PS₅Cl) had the lowest capacity of 112 mAh g⁻¹ and initial coulombic efficiency of 87.0%, which was because of the side reaction between sulfide and LiCoO₂. FIG. 6E amplifies the charge profiles of three cells in the initial cycle. The charge potential in cell-2 is 55 mV lower than that of cell-1, demonstrating the enhanced stability of Li₃InCl₆ against LiCoO₂ compared with Li₆PS₅Cl. Moreover, there is a 20 mV lower potential in cell-3 than that of cell-2, suggesting the lower internal resistance.

FIG. 6F compares the rate performances of three cells. Cell-3 exhibites rate capacities of 178, 179, 165, 134, and 124 mAh g⁻¹ (on average) at the current rates of C/20, C/10, C/5, C/2, and 1C, respectively (1C equals 200 mA/g). Moreover, the capacity recovers to 177 mAh g⁻¹ when recharged at C/10, demonstrating an outstanding rate performance. In comparison, cell-2 delivers similar capacity at low rates but greatly reduced capacities at high rates (101 mAh g⁻¹ at C/2, and 58 mAh g⁻¹ at 1C). The remarkably boosted rate performance in cell-3 is attributed to the reduced internal resistance (or enhanced ion conductance) caused by thinning the SE layer. The high resistance caused by the side reaction between LiCoO₂ and Li₆PS₅Cl explains the poor behavior of cell-1 at a high rate (only 25 mAh g⁻¹ at 1C). FIG. 6G shows the long-term cycling performances of cell-2 and cell-3 at the current rate of C/5. Cell-3 exhibites a remarkable initial capacity of 160 mAh g⁻¹ and maintained stability for 200 cycles with a capacity retention of 82%. The coulombic efficiency is higher than 99.8%. In contrast, cell-2 shows a lower initial capacity of 147 mAh g⁻¹. The environmental temperature variation causes the regular capacity vibration in both cells. The capacity vibration in cell-3 is more moderate than in cell-2, which is following that the ionic conductance of thin SE has lower temperature dependence than that of thick SE.

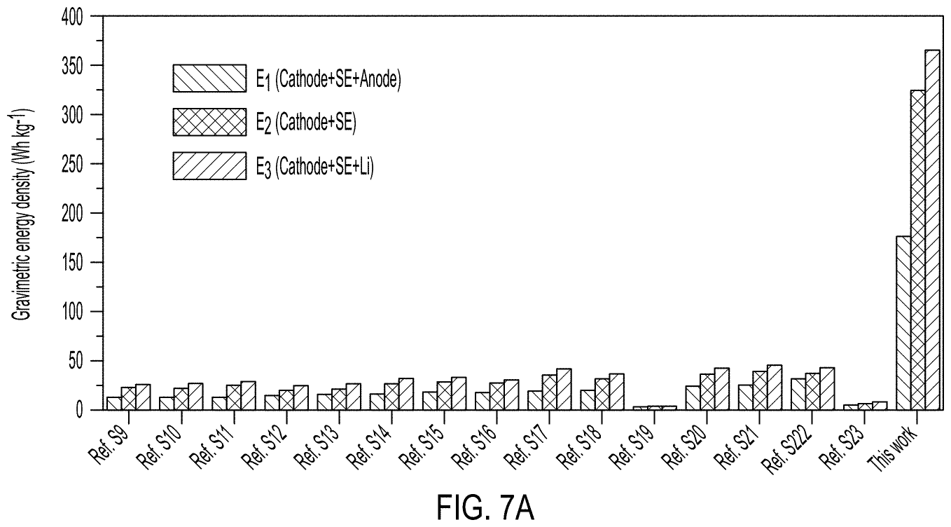

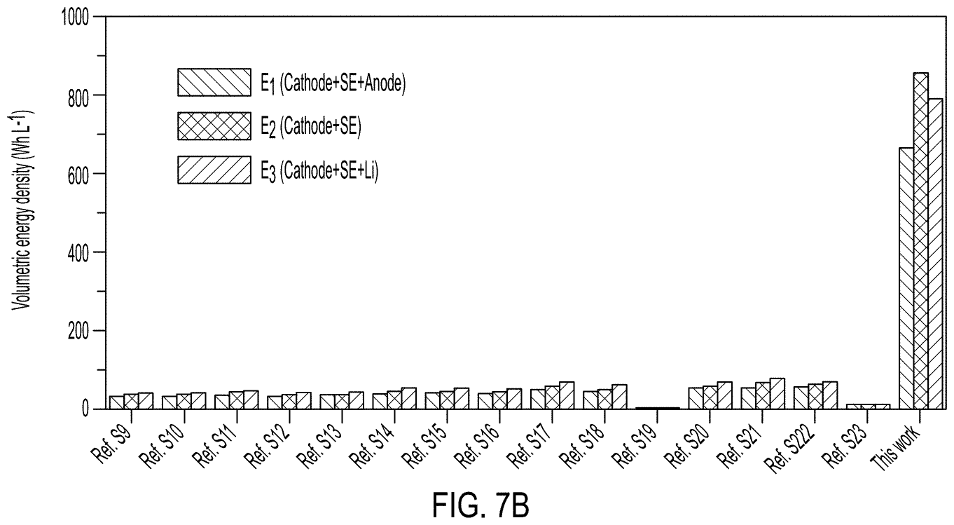

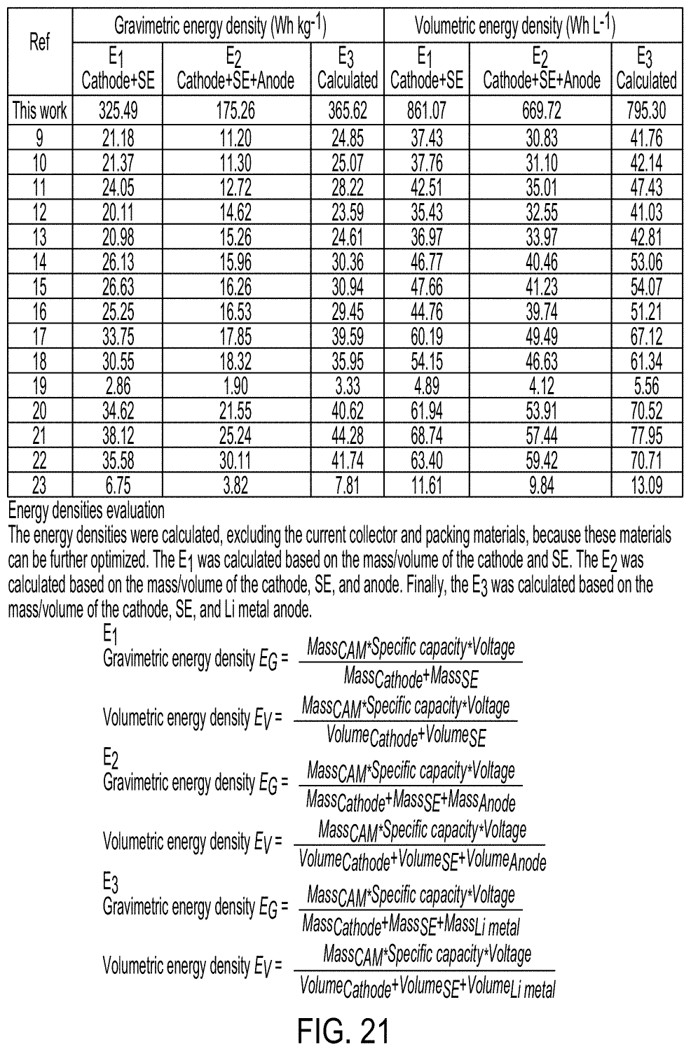

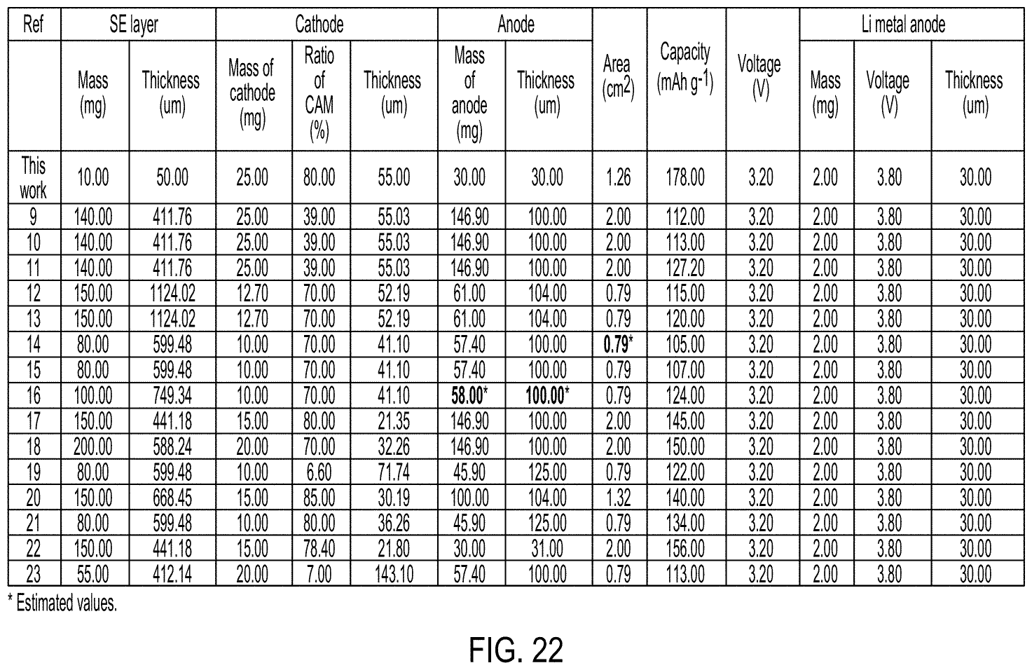

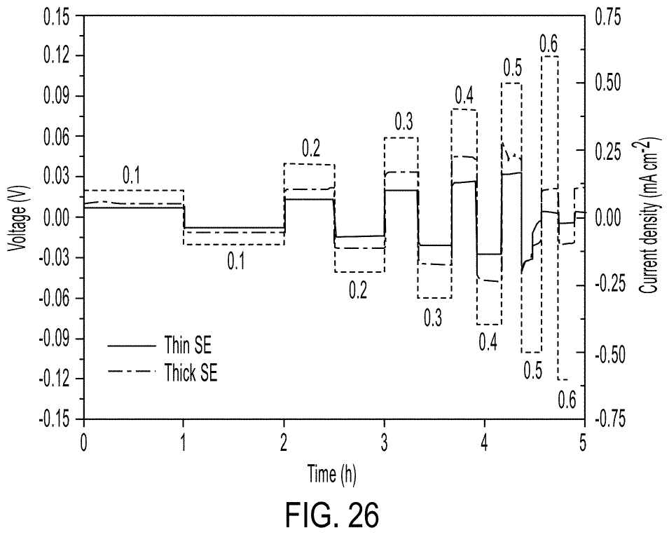

The gravimetric and volumetric energy densities of cell-3 were evaluated and compared with other reported ASLBs using LiCoO₂ cathode, sulfide SEs, and In (or In—Li) anode, as depicted in FIGS. 7A-B. The energy densities are calculated according to the weight and volume of the sum of 1) cathode, SE, and anode (E₁), and 2) only cathode and SE (E₂). E₃ is calculated as the perspective energy densities of cell-3 when employing Li metal anode. The detailed information on the energy density calculation listed in FIGS. 21 and 22. Cell-3 delivered remarkable E₁ energy densities (175 Wh kg⁻¹, 670 Wh L⁻¹) far exceeding that of other ASLBs (<30 Wh kg⁻¹, <60 Wh L⁻¹). The significant difference is highly related to replacing a thick SE pellet with a thin SE membrane. Considering In anode is generally considered to be an unfeasible for practical ASLBs, the E₂ energy densities that exclude the In anode weight in the calculation are discussed. As a result, cell-3 delivered an ultrahigh gravimetric energy density of 325 Wh kg⁻¹ and volumetric energy density of 861 Wh L⁻¹. Furthermore, the perspective E₃ energy densities of cell-3 reach 366 Wh kg⁻¹ and 795 Wh L⁻¹, respectively, attributing to the high energy density of Li metal. The critical current density (CCD) of thin SE membrane when coupled with Li metal is investigated and compared with thick SE. FIG. 26 displays the voltage profiles of these two symmetric cells during plating/stripping at a fixed capacity of 0.1 mAh cm⁻² but a step-increased current density from 0.1 to 0.6 mA cm⁻². Overall, the thin SE cell delivers a critical current density of 0.5 mA cm⁻², the same as the thick SE cell. It demonstrates that the thickness of the SE has a limited effect on its stability with Li metal. In addition, the overpotentials in thin SE are much lower than in thick SE, evidencing the much higher ion conductance in thin SE.

### CONCLUSION

The significance of developing a thin and highly ion-conductive SE membrane (thickness <50 μm, ionic conductivity >1.0 mS cm⁻¹) has attracted global interest in both academia and industries, but few works have achieved this number. Sulfide SEs are one of the most promising SEs to provide superior ion conduction. Even though the binder-assisted solution method is an effective method to prepare a thin SE membrane, it is challenging to find a binder that is both compatible with sulfide SE and solvent simultaneously, thermally stable, with strong binding tendencies. Nonpolar solvents are inevitable to avoid the degradation of sulfide SEs, but most binders are soluble in a nonpolar solvent. Therefore, the critical issue is employing an advanced binder that satisfies all requirements: 1) Excellent solubility and stability in the nonpolar solvent; 2) High stability with sulfide SE; 3) Outstanding thermal stability; 4) High binding strength; 5) Efficient dispersing capability.

Because of the unique amphipathic molecular structure of ethyl cellulose, combined with the binding and bonding effect, and the excellent compatibility with both Li₆PS₅Cl and toluene, we were able to fabricate a flexible, ultrathin, and robust SE membrane through a scalable vacuum filtration method. During the ASLB fabrication, Li₃InCl₆ acted as an interfacing stabilizer and ion conductor with LiCoO₂ cathode, promoting the reaction kinetic and long-term cycling stability. The reported sulfide SE membrane had a low thickness of 47 μm, lightweight of 7.9 mg cm⁻², a superior ionic conductivity of 1.08 mS cm⁻¹, ultralow areal resistance of 5.10 Ωcm², ultrahigh ion conductance of 190.11 mS, remarkable comparison robustness under a pressure of 80 MPa, and excellent flexibility. The ASLB employing this thin SE membrane delivered outstanding energy densities of 325 Wh kg⁻¹ and 861 Wh L⁻¹ based on cathode and SE layer, and cell-level energy densities of 175 Wh kg⁻¹ and 670 Wh L⁻¹. This work discovered a unique binder for large-scale manufacturing of ultrathin, robust, and highly ionic conductive SE membrane for cell-level high-energy ASLBs.

### Materials and Methods

### Materials Synthesis

Li₆PS₅Cl

The synthesis of Li₆PS₅Cl was based on our previous work. Briefly, Li₂S (Sigma-Aldrich, 99.98%), P₂S₅ (Sigma-Aldrich, 99%), and LiCl (Sigma-Aldrich, 99%) were stoichiometrically mixed through a ball milling for 10 h at 500 rpm. After that, the mixture was sealed in a glass tube and annealed at 550° C. for 6 h. The collected powder was the raw Li₆PS₅Cl. Next, the raw Li₆PS₅Cl was dispersed in toluene and experienced another ball milling process for 5 h at 400 rpm to achieve more fine particles. Finally, after a 200° C. treatment in Ar, the fine Li₆PS₅Cl powders were obtained.

Li₃InCl₆

The Li₃InCl₆ was prepared through an as-reported water-mediated approach.^{[32]} Firstly, stoichiometric InCl₃ (Sigma-Aldrich, 99.999%) and LiCl (Sigma-Aldrich, 99%) were dissolved in water in sequence. The mixture was then transferred to an oven and heated at 100° C. until the most visible water was removed. After that, the collected powders were further annealed at 200° C. for 7 h in a vacuum to remove the water to get the as-prepared Li₃InCl₆.

Li₃InCl₆—LiCoO₂

The preparation of the Li₃InCl₆—LiCoO₂ mixture was similar to the synthesis of Li₃InCl₆, as mentioned above. The LiCoO₂ powders (Rogers Inc.) were added into the as-prepared solution of InCl₃ and LiCl in weight ratios of 80:20. Before removing the water at 100° C. in an oven, the mixture was first treated in a bath sonication for 10 min. After the same water removal processes, the Li₃InCl₆—LiCoO₂ mixture was transferred into the glovebox and stored for future use.

### Thin Film Fabrication

Li₆PS₅Cl-Ethyl Cellulose Membrane

A vacuum filtration method was employed to prepare the thin membranes, conducted in the glovebox. Briefly, 2 mg of ethyl cellulose was first dissolved in 1 mL of toluene. After that, 98 mg of fine Li₆PS₅Cl powders were added to the ethyl cellulose solution, accompanied by continuous mechanical stirring to achieve uniform dispersion. The dispersion was then cast in the vacuum filtration system. A freestanding thin membrane can be obtained after peeling it off from the filter paper. The membrane was then sandwiched between two glass slides and heated at 150° C. for 12 h on a hot plate to remove the toluene completely. A commercial separator (Celgard 2400) was utilized as the filter paper due to limited pore size (43 nm). A coarse-frit glass filter (Fisher Scientific) with a diameter of 47 mm was used in the filtration process.

### Materials Characterization

The X-ray diffraction (XRD) was conducted on PANalytical/Philips X'Pert Pro with Cu Kα radiation. The Raman spectra were measured on a Thermo Scientific DXR with 532 nm laser excitation. The scanning electron microscopy (SEM) and energy dispersive X-ray spectroscopy (EDS) were characterized by SEM (JEPL JSM 7000F). The viscosity was performed on Discovery Hybrid Rheometer HR 30. The FTIR was measured on JASCO FT/IR-6600. The compression strength was conducted on a Zwick/Roell material testing machine.

### X-Ray Computed Tomography

For the XCT measurement, a Zeiss Xradia Versa 520 XCT unit was used; operated at 30 kV and 68 μA. For increased magnification and resolution, a 4× scintillator objective was used in front of the CCD camera. A 2×2 binning (on the detector) was used for optimized measurement time and resolution; resulting in a x=y=z=2.46 μm Pixel size. XCT data was collected over a sample rotation of w=360° with 1601 projections at equal steps. For image processing and segmentation, the ORS Dragonfly PRO v.3.5 software was used.

### Electrochemical Characterization

### Ionic Conductivity Measurement

The ionic conductivities of Li₆PS₅Cl powder, Li₆PS₅Cl-ethyl cellulose membrane, and Li₃InCl₆ powder were measured using EIS by symmetric systems with different ion-blocking electrodes. The ionic conductivity measurement of Li₆PS₅Cl powder can be found in our previous work.^{[23]} The Li₆PS₅Cl-ethyl cellulose membrane was first cut into a 12.7 mm circular sheet and then pressed under 300 MPa in a 12.7 mm PEEK die. Two pieces of indium foils (30 μm in thickness, 11.1 mm in diameter) were pressed onto two stainless steel plugs and then attached on both sides of the Li₆PS₅Cl-ethyl cellulose membrane in the die under 10 MPa. The total die with plugs was fixed in a stainless steel framework to conduct EIS directly. The ionic conductivity of Li₃InCl₆ was measured under similar processes with Li₆PS₅Cl except using stainless steel foil as electrodes to avoid the side reaction between Indium and Li₃InCl₆.

### Fabrication of ASLB Using Thick SE

The ASLB fabrication with thick SE was conducted in the glovebox. First, 200 mg of Li₆PS₅Cl powders were pressed in a PEEK die with a diameter of 12.7 mm under 300 MPa. Then 25 mg of as-prepared Li₃InCl₆—LiCoO₂ mixture was casted and then pressed on one side of the Li₆PS₅Cl under 100 MPa. A piece of In—Li was pressed on the other side with a pressure of 100 MPa to work as an anode. The Cu and stainless steel foil were selected as current collectors for anode and cathode, respectively. Finally, extra pressure of 50 MPa was applied to the cell and maintained with a stainless steel framework.

### Fabrication of ASLB Using Thin SE

The fabrication of ASLB using thin SE was similar to the fabrication of thick SE as aforementioned. A piece of In—Li foil was first pressed on the stainless steel plug with a diameter of 12.6 mm under a pressure of 300 MPa. After that, a 12.7 mm circular thin SE membrane was pressed on the In—Li foil in a PEEK die under 300 MPa. Then 25 mg of Li₃InCl₆—LiCoO₂ was cast on the top of thin SE and further pressed under 100 MPa. Finally, an extra pressure of 50 MPa was applied to the cell and maintained with a stainless steel framework.

### Rate and Cycling Performance

The rate and cycling measurement were conducted with a protocol that the cell was charged at constant current to 4.2 V, held at 4.2 V for 1 h, and then discharged to 2.5 V at a constant current. The current was calculated based on the mass and capacity of cathode active material. The rate performance was measured at C/20 for the first three cycles, then C/10, C/5, C/2, 1C for five cycles, respectively, and finally recovered to C/20 for another five cycles. Long-term cycling was conducted at C/5. Here 1C means 200 mA/g based on the weight of cathode active material.

### REFERENCES

[1] X. Feng, M. Ouyang, X. Liu, L. Lu, Y. Xia, X. He, Energy Storage Materials 2018, 10, 246.
[2] Z. P. Cano, D. Banham, S. Ye, A. Hintennach, J. Lu, M. Fowler, Z. Chen, Nature Energy 2018, 3, 279.
[3] Q. Zhang, D. Cao, Y. Ma, A. Natan, P. Aurora, H. Zhu, Adv. Mater. 2019, 31, 1970311.
[4] K. J. Kim, M. Balaish, M. Wadaguchi, L. Kong, J. L. M. Rupp, Advanced Energy Materials, n/a, 2002689.
[5] D. Cao, X. Sun, Q. Li, A. Natan, P. Xiang, H. Zhu, Matter 2020.
[6] D. Cao, Y. Zhao, X. Sun, A. Natan, Y. Wang, P. Xiang, W. Wang, H. Zhu, ACS Energy Letters 2020, 3468.
[7] J. Schnell, T. Günther, T. Knoche, C. Vieider, L. Köhler, A. Just, M. Keller, S. Passerini, G. Reinhart, Journal of Power Sources 2018, 382, 160.
[8] S. Randau, D. A. Weber, O. Kötz, R. Koerver, P. Braun, A. Weber, E. Ivers-Tiffée, T. Adermann, J. Kulisch, W. G. Zeier, F. H. Richter, J. Janek, Nature Energy 2020, 5, 259.
[9] J. Wu, L. Yuan, W. Zhang, Z. Li, X. Xie, Y. Huang, Energy & Environmental Science 2020.
[10] a) Y.-G. Lee, S. Fujiki, C. Jung, N. Suzuki, N. Yashiro, R. Omoda, D.-S. Ko, T. Shiratsuchi, T. Sugimoto, S. Ryu, J. H. Ku, T. Watanabe, Y. Park, Y. Aihara, D. Im, I. T. Han, Nature Energy 2020, 5, 299; b) W. Ping, C. Wang, R. Wang, Q. Dong, Z. Lin, A. H. Brozena, J. Dai, J. Luo, L. Hu, Science Advances 2020, 6, eabc8641.
[11] D. H. Kim, Y.-H. Lee, Y. B. Song, H. Kwak, S.-Y. Lee, Y. S. Jung, ACS Energy Letters 2020, 5, 718.
[12] a) Y. J. Nam, D. Y. Oh, S. H. Jung, Y. S. Jung, Journal of Power Sources 2018, 375, 93; b) D. Y. Oh, Y. J. Nam, K. H. Park, S. H. Jung, K. T. Kim, A. R. Ha, Y. S. Jung, Advanced Energy Materials 2019, 9, 1802927.
[13] H. Zhu, W. Luo, P. N. Ciesielski, Z. Fang, J. Y. Zhu, G. Henriksson, M. E. Himmel, L. Hu, Chemical Reviews 2016, 116, 9305.
[14] G. S. Rekhi, S. S. Jambhekar, Drug Dev. Ind. Pharm. 1995, 21, 61.
[15] P. Ahmadi, A. Jahanban-Esfahlan, A. Ahmadi, M. Tabibiazar, M. Mohammadifar, Food Reviews International 2020, 1.
[16] L. W. McKeen, in Film Properties of Plastics and Elastomers (Third Edition), (Ed: L. W. McKeen), William Andrew Publishing, Boston 2012, 353.
[17] R. Giernoth, in Solvents and Solvent Effects in Organic Chemistry, 2010, 509.
[18] V. Hospodarova, E. Singovszka, N. Stevulova, American Journal of Analytical Chemistry 2018, 9, 303.
[19] X. Wu, L. Zhang, X. Zhang, Y. Zhu, Y. Wu, Y. Li, B. Li, S. Liu, J. Zhao, Z. Ma, Scientific Reports 2017, 7, 12079.
[20] F. J. Simon, M. Hanauer, F. H. Richter, J. Janek, ACS Applied Materials & Interfaces 2020, 12, 11713.
[21] Y. E. Aimene, J. A. Nairn, Wood Science and Technology 2015, 49, 21.
[22] M. Xuan, W. Xiao, H. Xu, Y. Shen, Z. Li, S. Zhang, Z. Wang, G. Shao, Journal of Materials Chemistry A 2018, 6, 19231.
[23] D. Cao, Y. Zhang, A. M. Nolan, X. Sun, C. Liu, J. Sheng, Y. Mo, Y. Wang, H. Zhu, Nano Lett. 2019, 20, 1483.
[24] T. Yersak, J. R. Salvador, R. D. Schmidt, M. Cai, ACS Applied Energy Materials 2019, 2, 3523.
[25] J. A. Lewis, F. J. Q. Cortes, Y. Liu, J. C. Miers, A. Verma, B. S. Vishnugopi, J. Tippens, D. Prakash, T. S. Marchese, S. Y. Han, C. Lee, P. P. Shetty, H.-W. Lee, P. Shevchenko, F. De Carlo, C. Saldana, P. P. Mukherjee, M. T. McDowell, Nature Materials 2021, 20, 503.
[26] Z. Ning, D. S. Jolly, G. Li, R. De Meyere, S. D. Pu, Y. Chen, J. Kasemchainan, J. Ihli, C. Gong, B. Liu, D. L. R. Melvin, A. Bonnin, O. Magdysyuk, P. Adamson, G. O. Hartley, C. W. Monroe, T. J. Marrow, P. G. Bruce, Nature Materials 2021.
[27] J.-M. Doux, Y. Yang, D. H. S. Tan, H. Nguyen, E. A. Wu, X. Wang, A. Banerjee, Y. S. Meng, Journal of Materials Chemistry A 2020, 8, 5049.
[28] L. Wang, B. Chen, J. Ma, G. Cui, L. Chen, Chem. Soc. Rev. 2018, 47, 6505.
[29] N. Ohta, K. Takada, L. Zhang, R. Ma, M. Osada, T. Sasaki, Advanced Materials 2006, 18, 2226.
[30] X. Li, J. Liang, X. Yang, K. R. Adair, C. Wang, F. Zhao, X. Sun, Energy & Environmental Science 2020, 13, 1429.
[31] C. Wang, J. Liang, M. Jiang, X. Li, S. Mukherjee, K. Adair, M. Zheng, Y. Zhao, F. Zhao, S. Zhang, R. Li, H. Huang, S. Zhao, L. Zhang, S. Lu, C. V. Singh, X. Sun, Nano Energy 2020, 76, 105015.
[32] X. Li, J. Liang, N. Chen, J. Luo, K. R. Adair, C. Wang, M. N. Banis, T.-K. Sham, L. Zhang, S. Zhao, S. Lu, H. Huang, R. Li, X. Sun, Angewandte Chemie (International ed. in English) 2019, 58, 16427.

### REFERENCES FOR SUPPLEMENTARY INFORMATION

1. Y. J. Nam, S.-J. Cho, D. Y. Oh, J.-M. Lim, S. Y. Kim, J. H. Song, Y.-G. Lee, S.-Y. Lee and Y. S. Jung, Nano Lett., 2015, 15, 3317-3323.
2. D. Y. Oh, D. H. Kim, S. H. Jung, J.-G. Han, N.-S. Choi and Y. S. Jung, J. Mater. Chem. A, 2017, 5, 20771-20779.
3. R. Xu, J. Yue, S. Liu, J. Tu, F. Han, P. Liu and C. Wang, ACS Energy Lett., 2019, 4, 1073-1079.
4. D. H. Kim, Y.-H. Lee, Y. B. Song, H. Kwak, S.-Y. Lee and Y. S. Jung, ACS Energy Lett., 2020, 5, 718-727.
5. Y. Li, X. Wang, H. Zhou, X. Xing, A. Banerjee, J. Holoubek, H. Liu, Y. S. Meng and P. Liu, ACS Energy Lett., 2020, 5, 955-961.
6. M. Yamamoto, Y. Terauchi, A. Sakuda and M. Takahashi, Sci. Rep., 2018, 8, 1212.
7. S. Luo, Z. Wang, A. Fan, X. Liu, H. Wang, W. Ma, L. Zhu and X. Zhang, J. Power Sources, 2021, 485, 229325.
8. J. M. Whiteley, P. Taynton, W. Zhang and S.-H. Lee, Adv. Mater., 2015, 27, 6922-6927.
9. S. Choi, J. Kim, M. Eom, X. Meng and D. Shin, J. Power Sources, 2015, 299, 70-75.
10. J. Kim, M. Eom, S. Noh and D. Shin, J. Power Sources, 2013, 244, 476-481.
11. S. Noh, J. Kim, M. Eom and D. Shin, Ceram. Int., 2013, 39, 8453-8458.
12. N. Ohta, K. Takada, L. Zhang, R. Ma, M. Osada and T. Sasaki, Adv. Mater., 2006, 18, 2226-2229.
13. N. Ohta, K. Takada, I. Sakaguchi, L. Zhang, R. Ma, K. Fukuda, M. Osada and T. Sasaki, Electrochem. Commun., 2007, 9, 1486-1490.
14. H. Kitaura, A. Hayashi, T. Ohtomo, S. Hama and M. Tatsumisago, J. Mater. Chem., 2011, 21, 118-124.
15. S. Teragawa, K. Aso, K. Tadanaga, A. Hayashi and M. Tatsumisago, J. Power Sources, 2014, 248, 939-942.
16. W. J. Li, M. Hirayama, K. Suzuki and R. Kanno, Solid State Ionics, 2016, 285, 136-142.
17. S. Noh, W. T. Nichols, C. Park and D. Shin, Ceram. Int., 2017, 43, 15952-15958.
18. S. Noh, W. T. Nichols, M. Cho and D. Shin, J. Electroceram., 2018, 40, 293-299.
19. W. Zhang, T. LeichtweiB, S. P. Culver, R. Koerver, D. Das, D. A. Weber, W. G. Zeier and J. Janek, ACS Appl. Mater. Inter., 2017, 9, 35888-35896.
20. Y. E. Choi, K. H. Park, D. H. Kim, D. Y. Oh, H. R. Kwak, Y.-G. Lee and Y. S. Jung, ChemSusChem, 2017, 10, 2605-2611.
21. W. Zhang, D. A. Weber, H. Weigand, T. Arlt, I. Manke, D. Schröder, R. Koerver, T. Leichtweiss, P. Hartmann, W. G. Zeier and J. Janek, ACS Appl. Mater. Inter., 2017, 9, 17835-17845.
22. M. Eom, S. Choi, S. Son, L. Choi, C. Park and D. Shin, J. Power Sources, 2016, 331, 26-31.
23. H. Takahara, T. Takeuchi, M. Tabuchi, H. Kageyama, Y. Kobayashi, Y. Kurisu, S. Kondo and R. Kanno, J. Electrochem. Soc., 2004, 151, A1539.

### INCORPORATION BY REFERENCE; EQUIVALENTS

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A method of making a solid-state electrolyte, the method comprising:
a. dissolving ethyl cellulose in a nonpolar solvent;
b. dispersing a sulfide solid electrolyte in the nonpolar solvent;
c. casting the dispersion of the sulfide solid electrolyte in the nonpolar solvent under vacuum filtration to form a thin membrane; and
d. heating the thin membrane to remove the nonpolar solvent, thereby forming a solid-state electrolyte.

2. The method of claim 1, wherein the nonpolar solvent is toluene.

3. The method of claim 1, wherein the sulfide solid electrolyte is Li₆PS₅Cl.

4. The method of claim 1, wherein the solid-state electrolyte has a thickness from about 20 μm to about 50 μm.

5. (canceled)

6. The method of claim 1, wherein the solid-state electrolyte has a thickness of less than 50 μm.

7. The method of claim 1, wherein the solid-state electrolyte has a resistance of less than 20Ω at 30° C.

8. The method of claim 1, wherein the solid-state electrolyte as a resistance from 5Ω to 20Ω at 30° C.

9. The method of claim 1, wherein the solid-state electrolyte has a resistance of about 5.26Ω at 30° C.

10. The method of claim 1, wherein the solid-state electrolyte has a conductivity of at least 0.75 mS cm⁻¹ at 30° C.

11. The method of claim 1, wherein the solid-state electrolyte as a conductivity from 0.75 mS cm⁻¹ to 5 mS cm⁻¹ at 30° C.

12. (canceled)

13. The method of claim 1, wherein the solid-state electrolyte has an ion conductance of at least 150 mS at 30° C.

14. The method of claim 1, wherein the solid-state electrolyte as an ion conductance from about 150 mS to about 300 mS at 30° C.

15. (canceled)

16. The method of claim 1, wherein the solid-state electrolyte has from about 1 wt. % ethyl cellulose to about 5 wt. % ethyl cellulose.

17. The method of claim 1, wherein the solid-state electrolyte has less than about 1 vol % pores.

18. The method of claim 1, wherein the solid-state electrolyte has from about 0.05 vol. % pores to about 3 vol. % pores.

19. (canceled)

20. The method of claim 1, wherein chlorine, sulfur, and phosphorus are homogeneously distributed throughout the solid-state electrolyte.

21. The method of claim 1, wherein the ethyl cellulose does not interrupt ion conductance of the solid state electrolyte.

22. (canceled)

23. A method of making a cathode, the method comprising:
a. dissolving LiCl in water;
b. dissolving InCl₃ in the water;
c. dispersing LiCoO₂ in the water;
d. heating the water with dissolved LiCl, dissolved InCl₃, and dispersed LiCoO₂ to remove the water, thereby forming a mixture of LiCoO₂ and Li₃InCl₆; and
e. annealing the mixture of LiCoO₂ and Li₃InCl₆.

24-26. (canceled)

27. A battery comprising:
a. a cathode current collector;
b. a cathode comprising LiCoO₂ and Li₃InCl₆;
c. a solid-state electrolyte comprising a sulfide solid electrolyte and ethyl cellulose;
d. an anode; and
e. an anode current collector.

28-37. (canceled)

38. A method of making a battery, the method comprising:
a. pressing together:
i. a cathode comprising LiCoO₂ and Li₃InCl₆;
ii. a solid-state electrolyte comprising a sulfide solid electrolyte and ethyl cellulose; and
iii. an anode comprising In—Li;
b. attaching a cathode current collector to the cathode; and
c. attaching an anode current collector to the anode.
